(19) United States
(12) Patent Application Publication
(10) Pub. No.: US 2015/0006423 A1
(43) Pub. Date: Jan. 1, 2015

(54) INDIVIDUALIZED EDUCATION CONSULTING SYSTEM AND METHOD

(71) Applicant: ThinkTank Learning Inc., Santa Clara, CA (US)

(72) Inventors: Steven Ma, San Joase, CA (US); Stanley Chung Shun Wei, Fremont, CA (US)

(21) Appl. No.: 13/931,232

(22) Filed: Jun. 28, 2013

(51) Int. Cl. G06Q 50/20; G06Q 10/00

(52) U.S. Cl. CPC G06Q 50/205; G06Q 10/00
USPC 705/327

(57) ABSTRACT

The present invention provides a method and system for individualized academic counseling in an educational consulting company. The system is designed to build a customized plan for each of the student's unique needs. Based on his/her personality, individual interests, and current academic performance, it generates an extracurricular activity plan, internship development, essay assistance, diagnostic report, chances of admission analysis, one-on-one tutoring, and premium college application consultation.

### FIELD OF THE INVENTION

The present invention generally relates to methods and systems for maintaining, transforming, and utilizing data for an educational consulting business, and more specifically relates to a system for individualized education consulting.

### BACKGROUND OF THE INVENTION

Education does not begin and end with test preparation classes, tutoring, or college applications. It is the culmination of years of academic and personal development. An educational consulting business can offer individualized academic counseling, extracurricular activity and internship development, one-on-one tutoring, and premium college application consultation.

Within this educational consulting business, different tasks are performed by different people. For instance, the education consultants (or consultants) need to keep track of each student's data, which includes GPA, SAT or ACT, school grades, plan for extracurricular activities (EA), internships, conduct intake and generate strategic positioning results, decide tutoring needs, monitor classes' progress, make school selections, and check on application status. The tutors need to keep track of his/her student list, curriculum, progress, and teaching hours. A manager needs to manage classrooms, finance, and prepares for call log reports, marketing and sales reports and each client's contract management. Human resource personnel support entire company's recruiting, training, and award determination. Sales and marketing personnel are responsible for new product development, study client's address to determine the location of the next new center and advertisement. System engineers are implementing the data centralization and permission control, score data representation based on different formulas, and all the system requirements from every role and department within the company.

There are conventional tools that can help education consultants/counselors to check on students scores (SAT, GPA, Honors, school grades etc.) and perform school selections for their students. However, these tools do not support individualized academic counseling, such as conducting personal intakes (interviews) and writing up a strategic positioning statement for a particular student for his/her college application essays. These conventional tools will not perform extracurricular activities analysis based on the student's unique interest; they do not provide analysis for chances of admissions, and they do not do a diagnostic based on student's current information so the student knows which areas to improve upon. A method or system with effective data analysis and management functions is hence needed in such a business, which facilitates the communication between the consultants, tutors, managers, parents, system engineers, and students; and ensures data sharing, updating, and delivering effectively.

### SUMMARY OF THE INVENTION

The present invention has been made to overcome the aforementioned disadvantages of conventional methods. The primary object of the present invention is to provide a method and system for individualized academic counseling in an educational consulting company. The educational counseling system is a data management system, which is designed to ‘customer build’ for each of the client's unique needs. Based on student's personality and individualized requirements, the educational counseling system generates an extracurricular activity (EA) plan, performs internship development, one-on-one tutoring, personalized diagnostic, and premium college application consultation.

The consulting process normally starts with a minimum two-hour intake, which is for an education consultant (or a consultant throughout the application) to meet the student and conduct an interview with the student at the beginning of the consultation. After the intake, the education consultant will have to write up a strategic positioning statement for the student, which is a summary of the student's strengths, efforts, and endeavors based on his/her past experiences. The strategic positioning statement will be a guideline for the student's college essays as well as a reminder for the education consultant to follow up on certain weakness of the student. The consulting process will be a long-term effort, at times involving parents to collect more information about the student. The strategic positioning statement will lead to a brainstorm document later for each of the college essay topics. The education consultant needs to find out what the student's interests and strengths are, and search for an extracurricular activity for the student. The education consultant will do school selection for the student as well; the educational counseling system provides a ‘diagnostic’ function based on a preselected school tier (e.g. tier one is for US News ranked 1-16 schools), which will produce an analyzed result for Academics, Standardized Tests, and EAs for the student, so the student knows which area(s) to improve upon in order to achieve the school tier he/she has preselected.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 illustrates a window showing the educational counseling system log in screen;

FIG. 2, a window showing opening screen for a consultant;

FIG. 3, a window showing ‘Message’ screen for a consultant;

FIG. 3.1, a window showing the ‘Create Message’ screen, an option under ‘Message’;

FIG. 3.2, a window showing the ‘Manage Message’ screen, an option under ‘Message’;

FIG. 3.3, a window showing the ‘Flame’ screen, an option under ‘Message’;

FIG. 4, a window showing the ‘View/Search Students’ screen, an option under ‘User Mgmt’;

FIG. 4.1, a window showing the ‘View My Students’ screen;

FIG. 41.1, a window showing the ‘Intake’ screen after a designated student's name is selected;

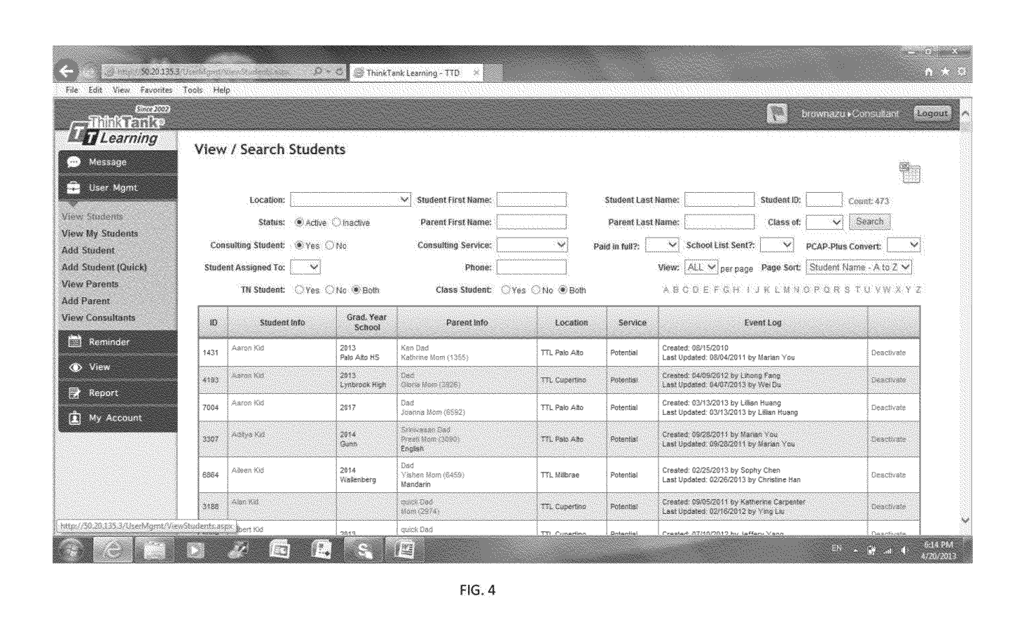

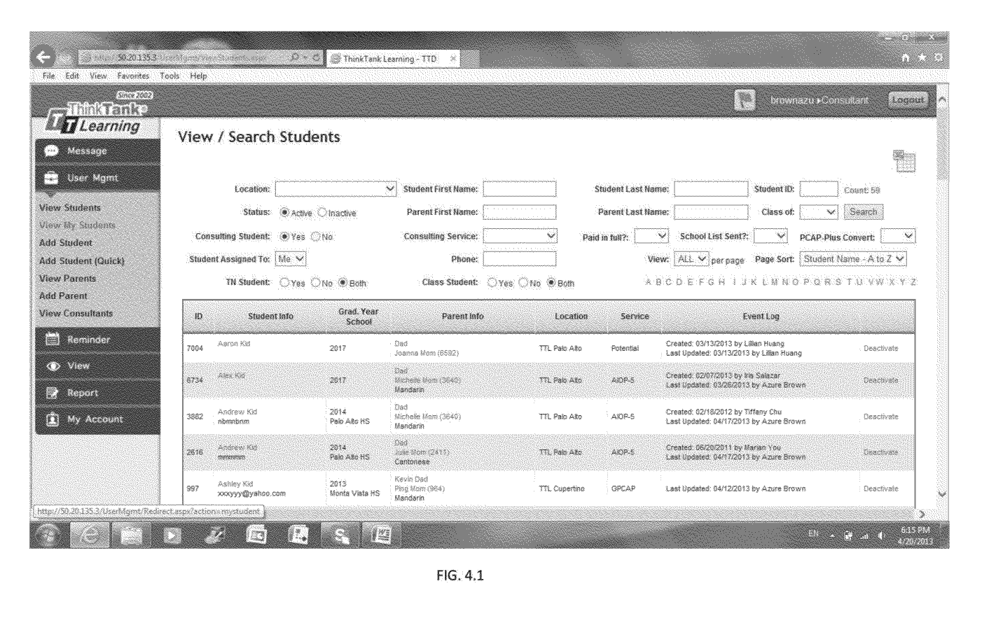

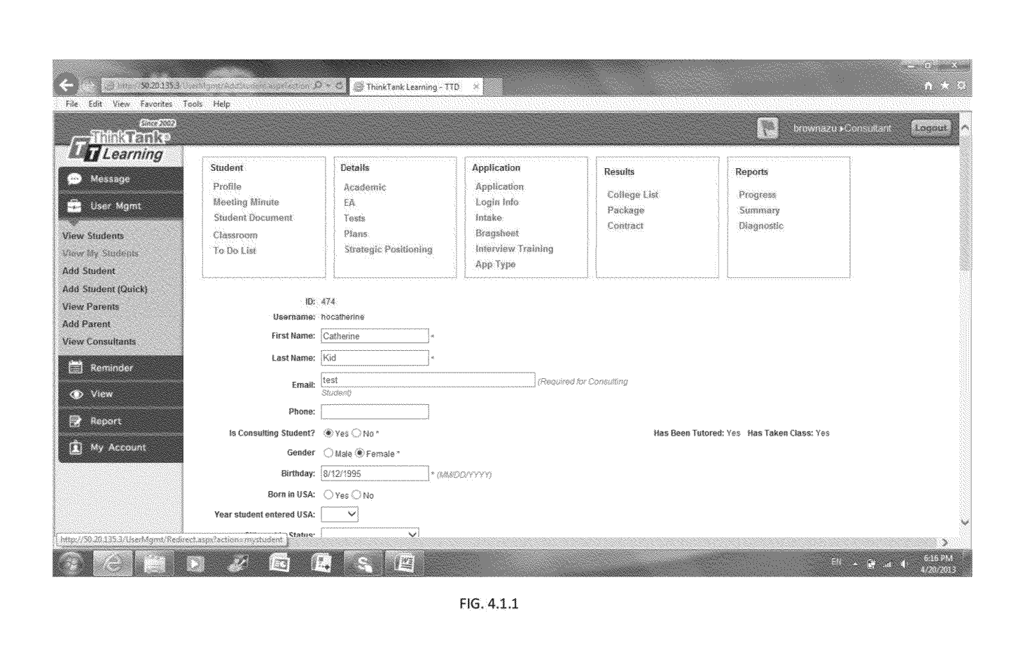

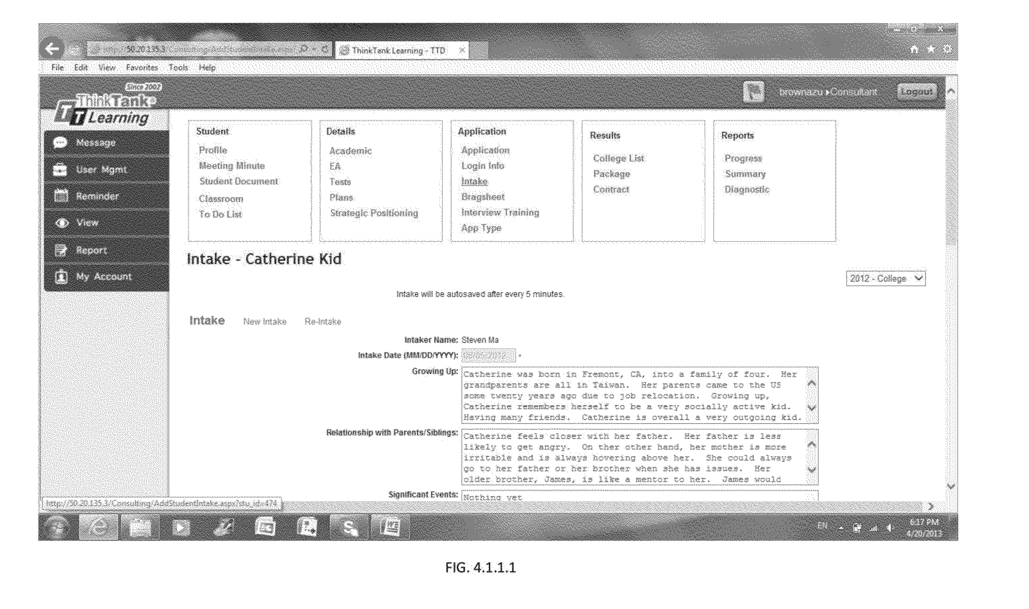

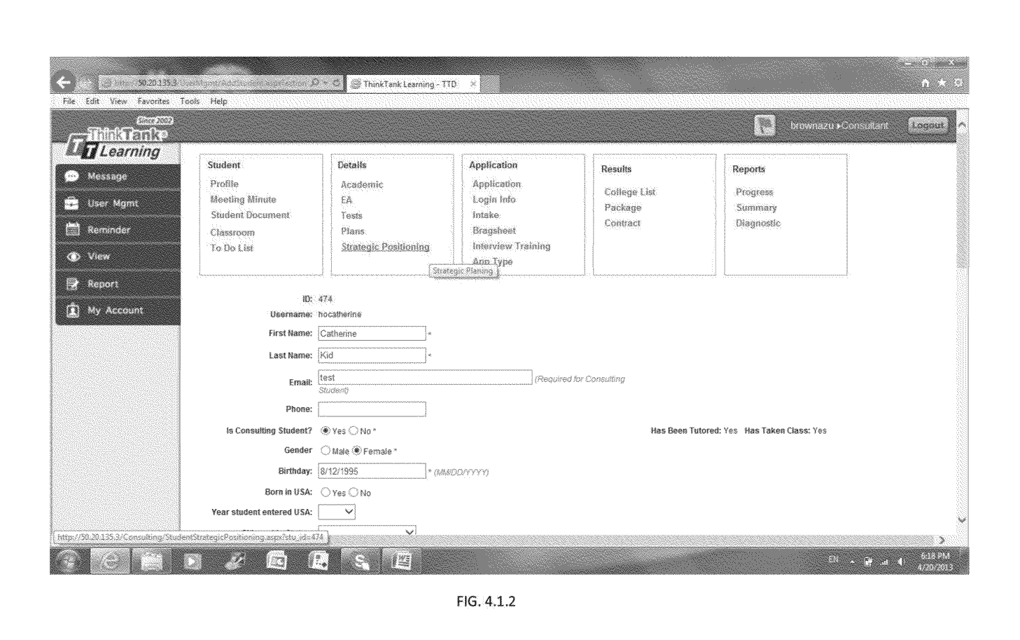

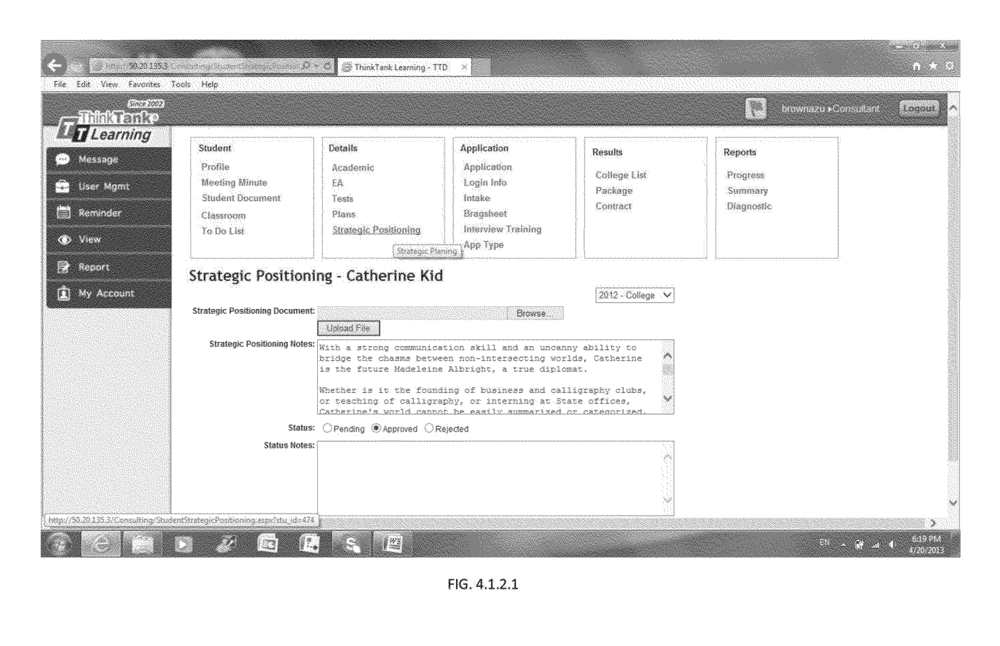

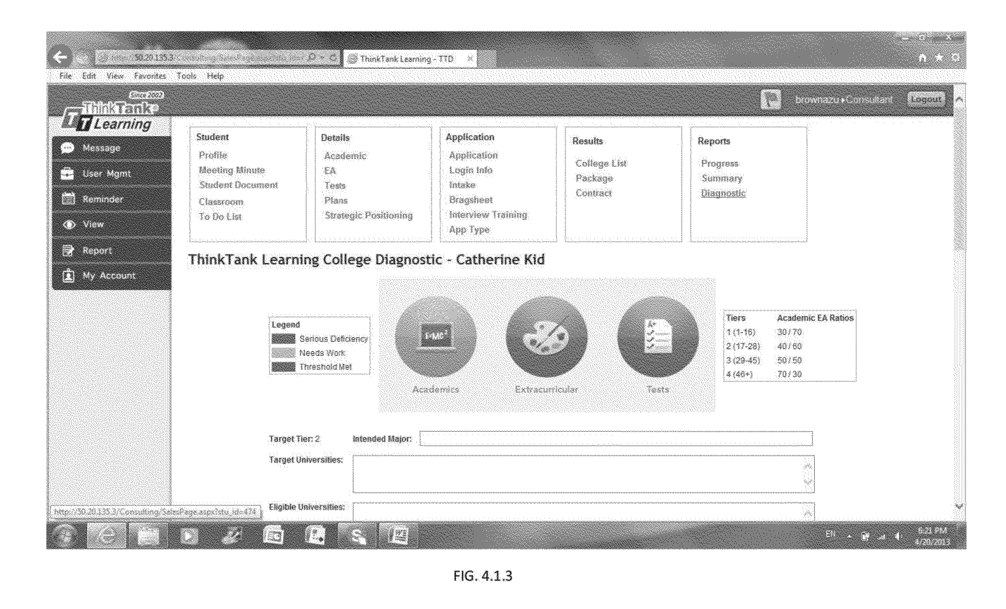

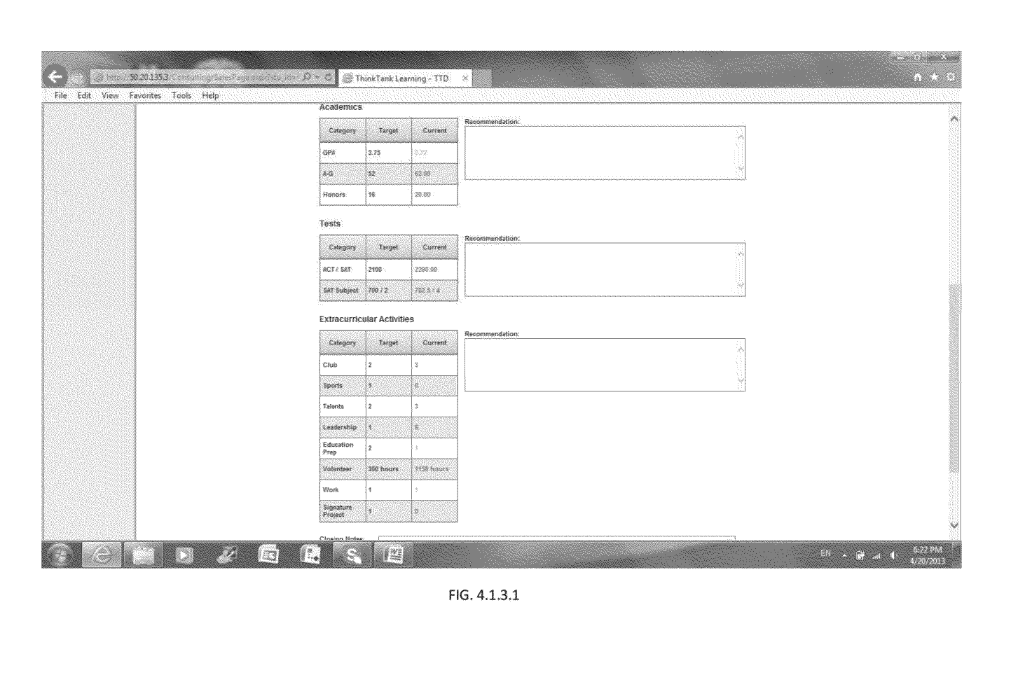

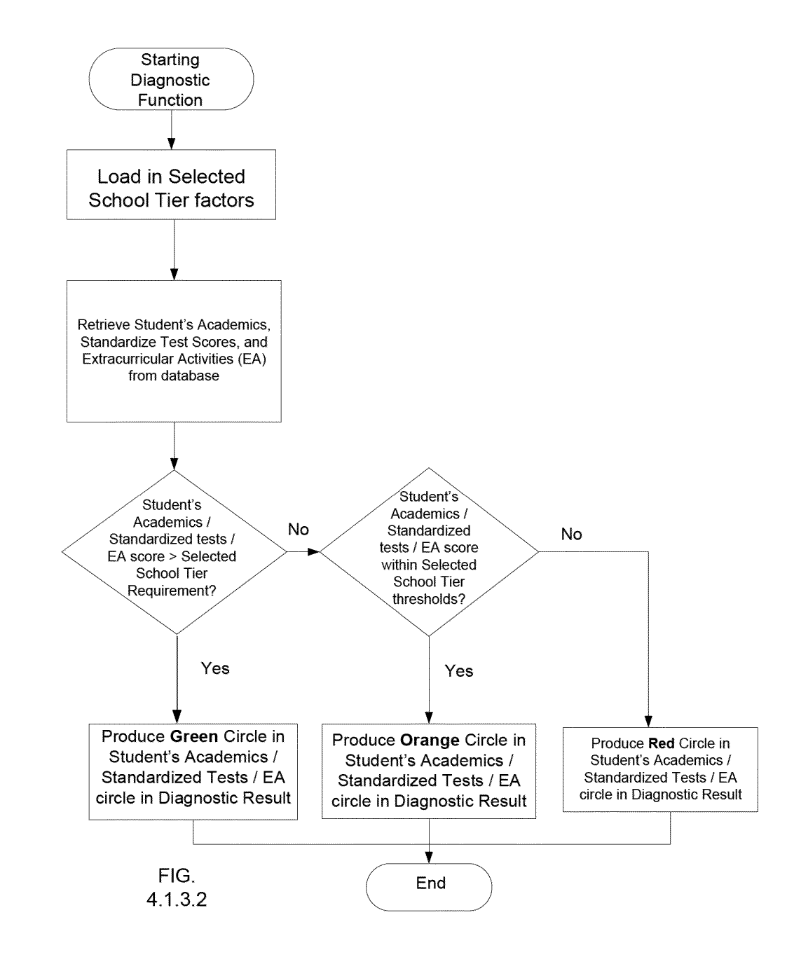

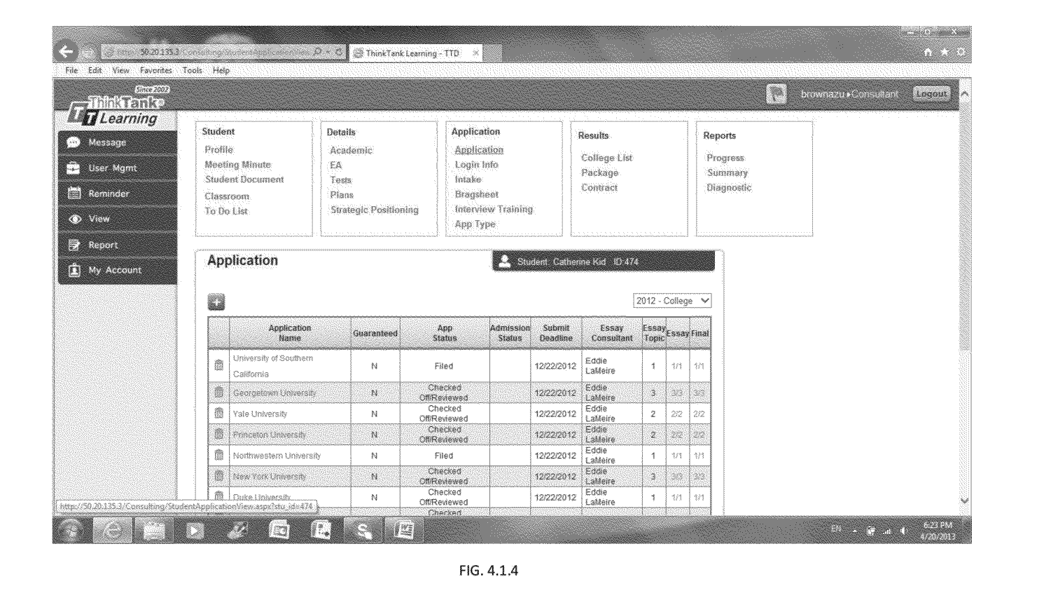

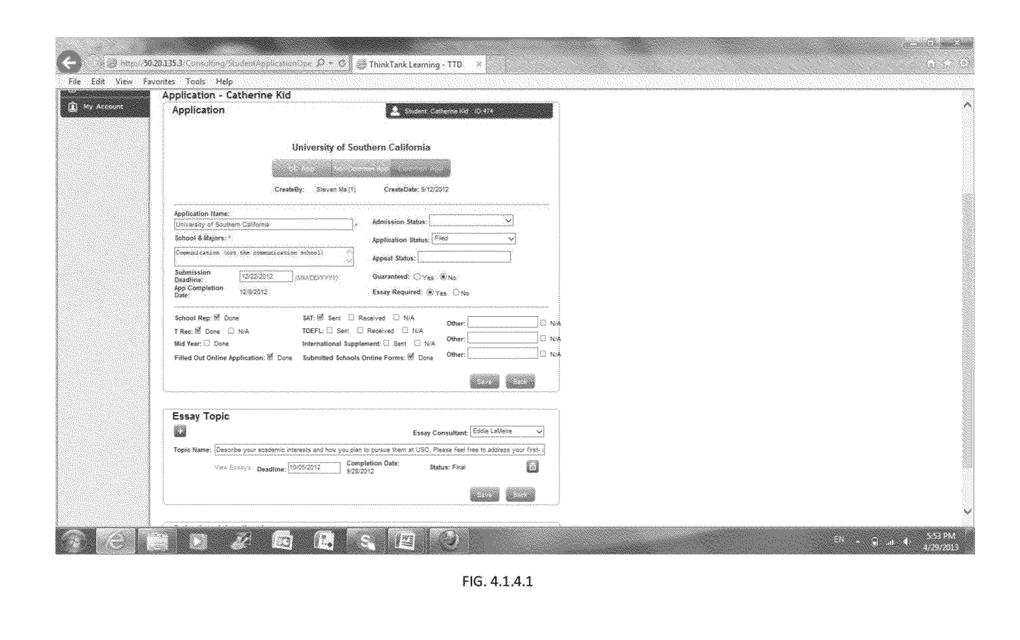

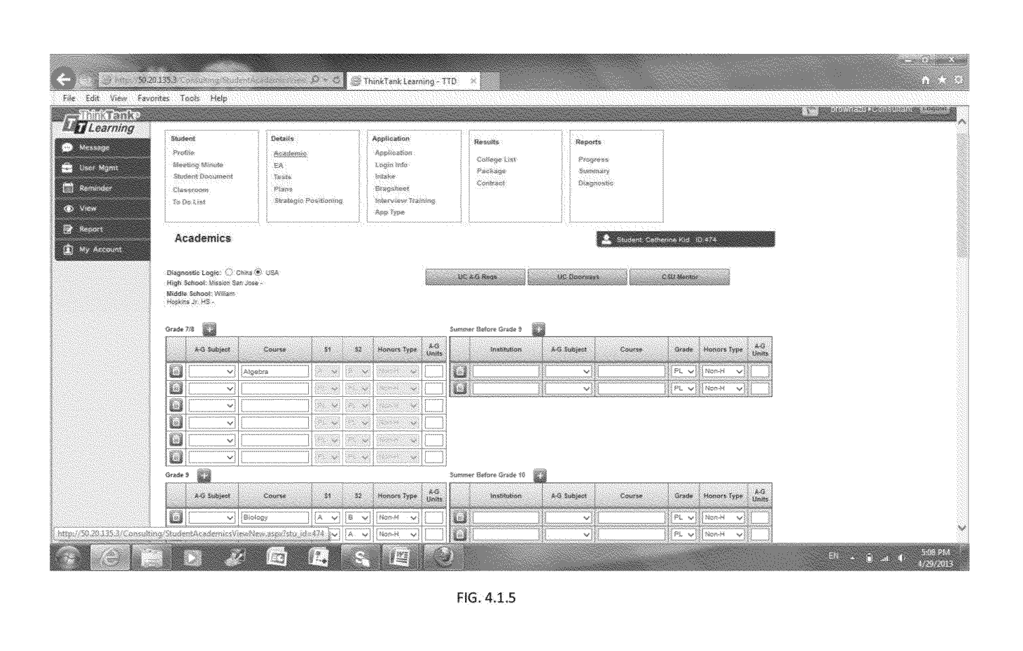

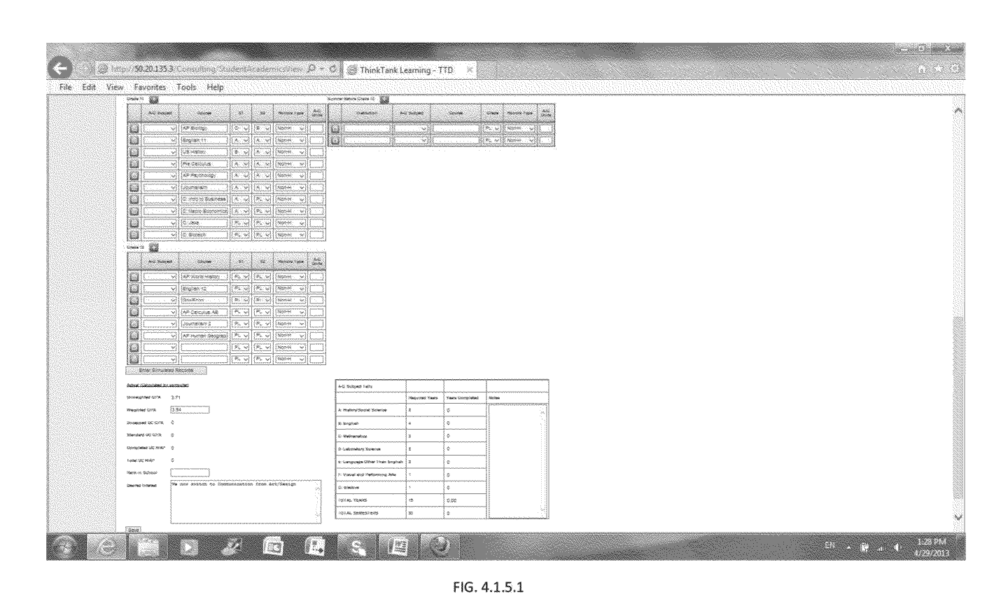

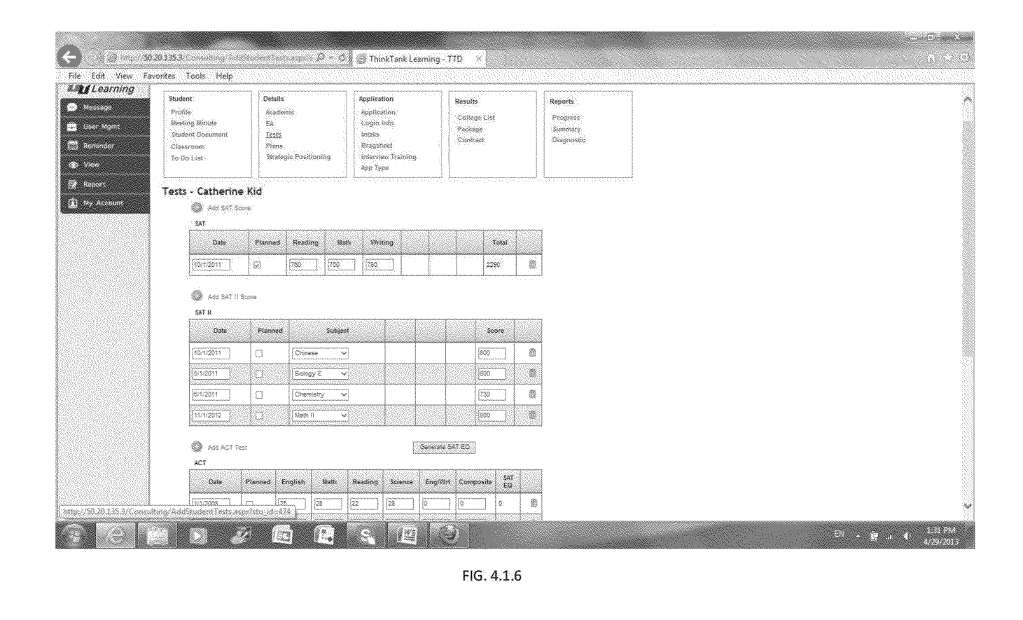

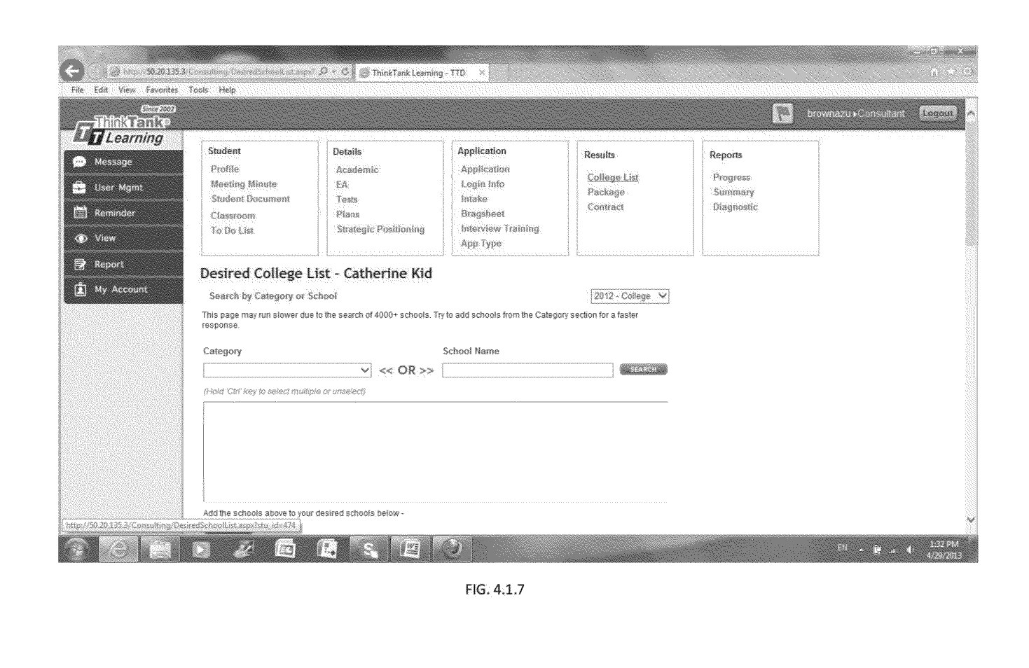

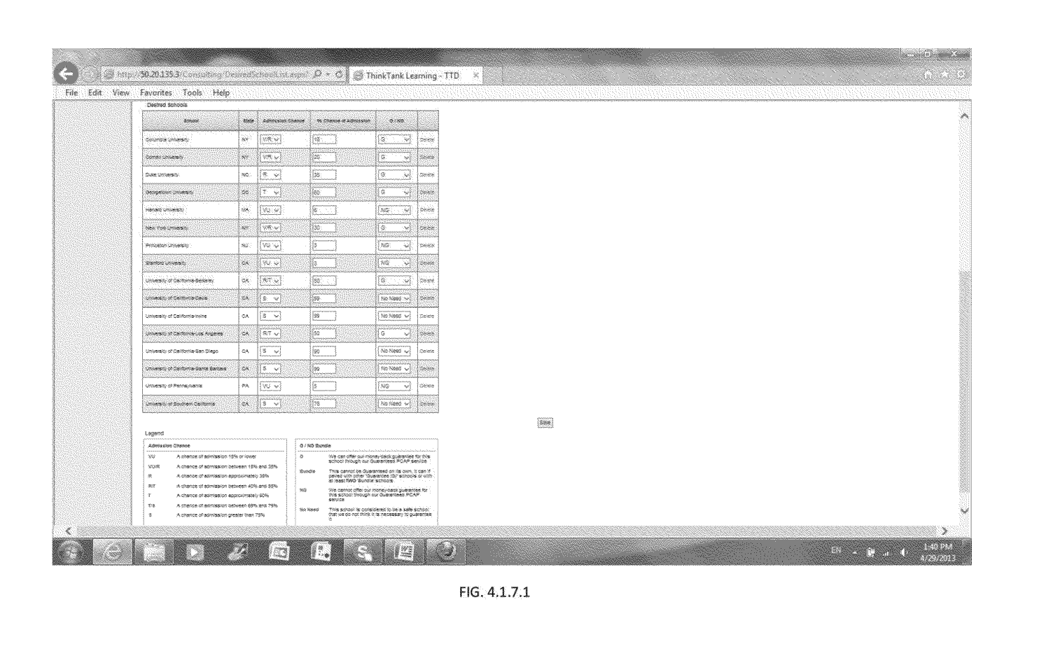

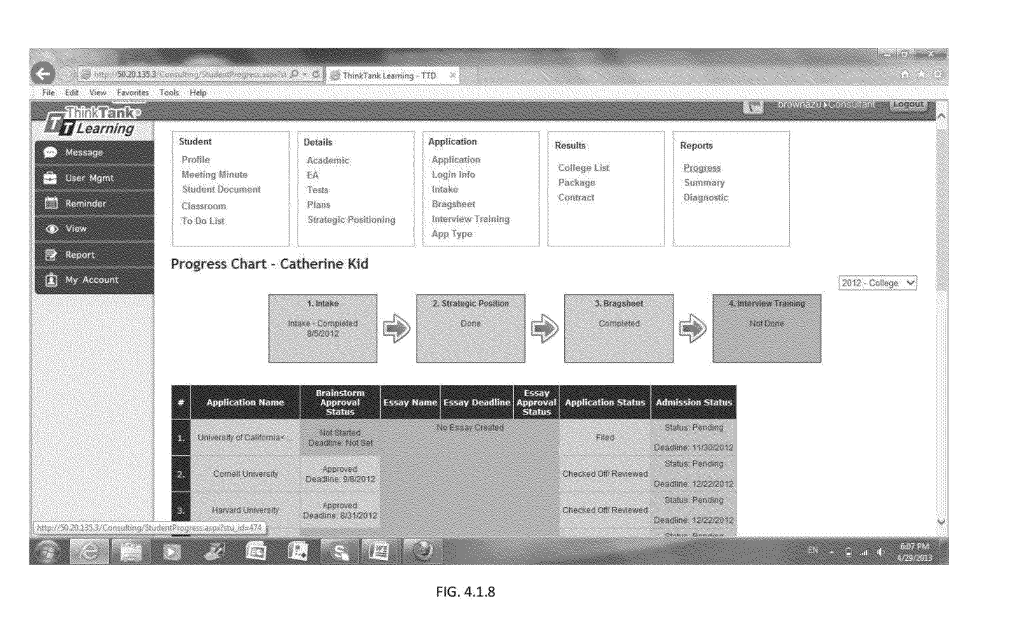

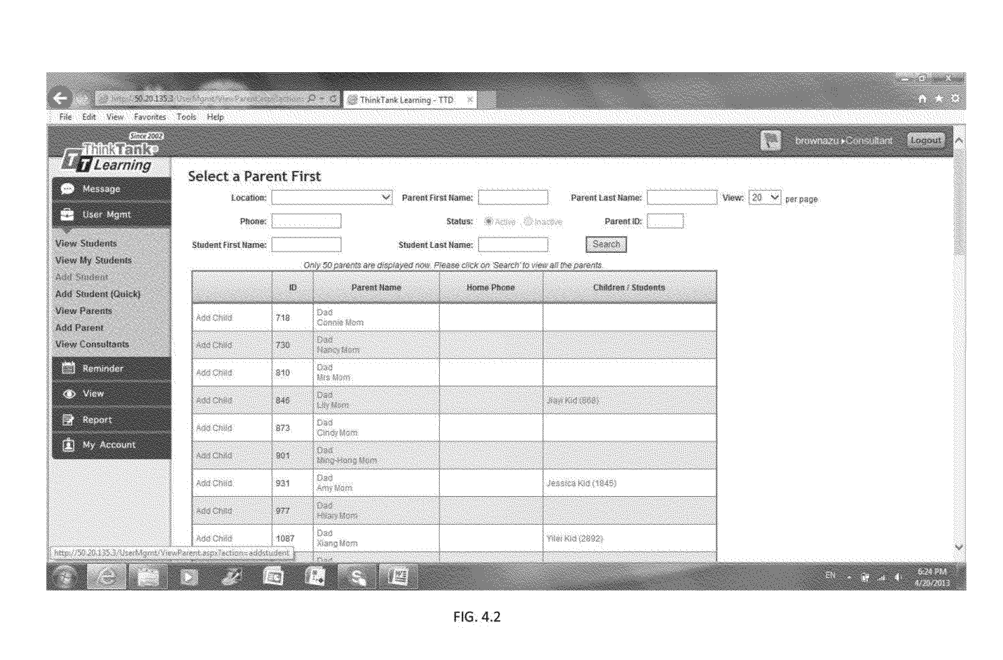

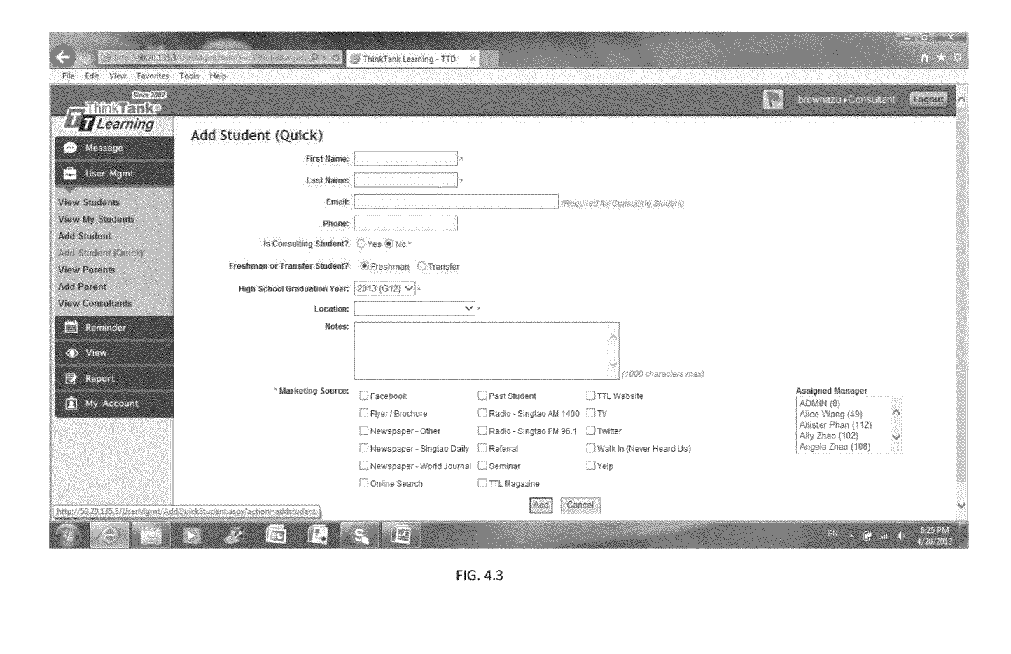

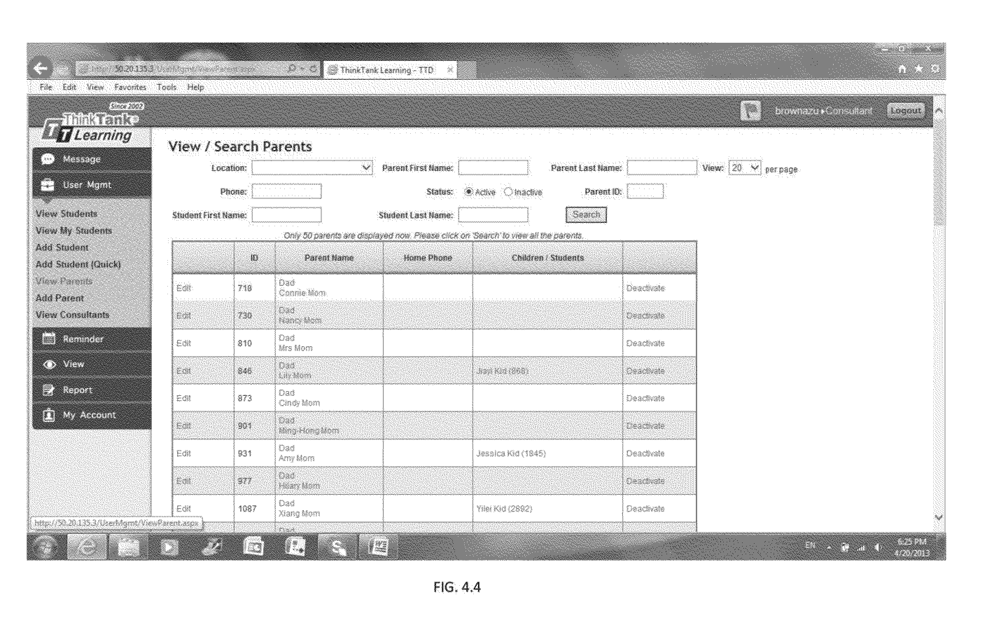

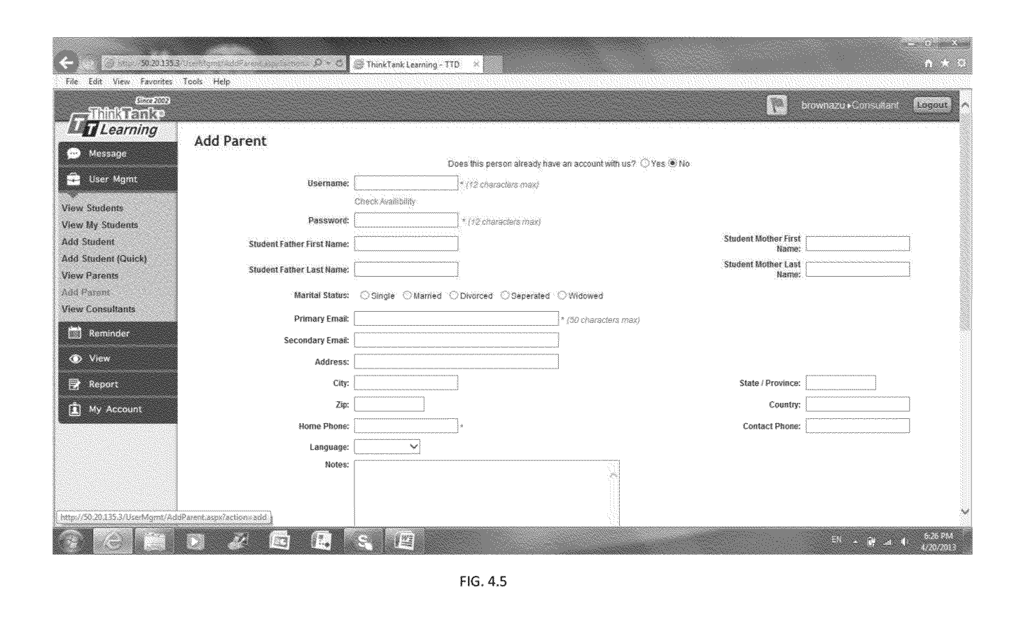

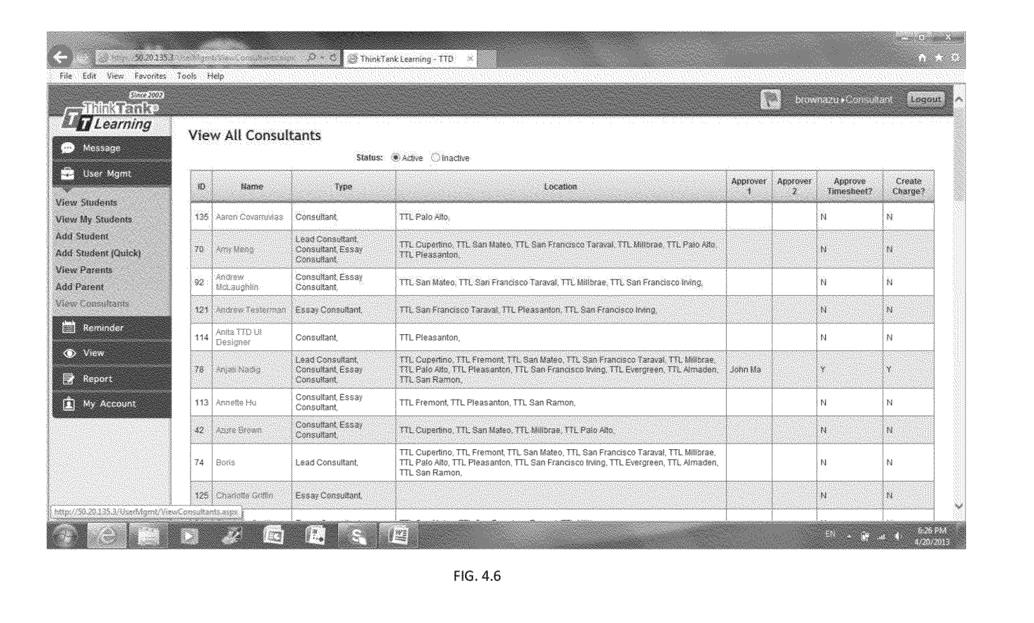

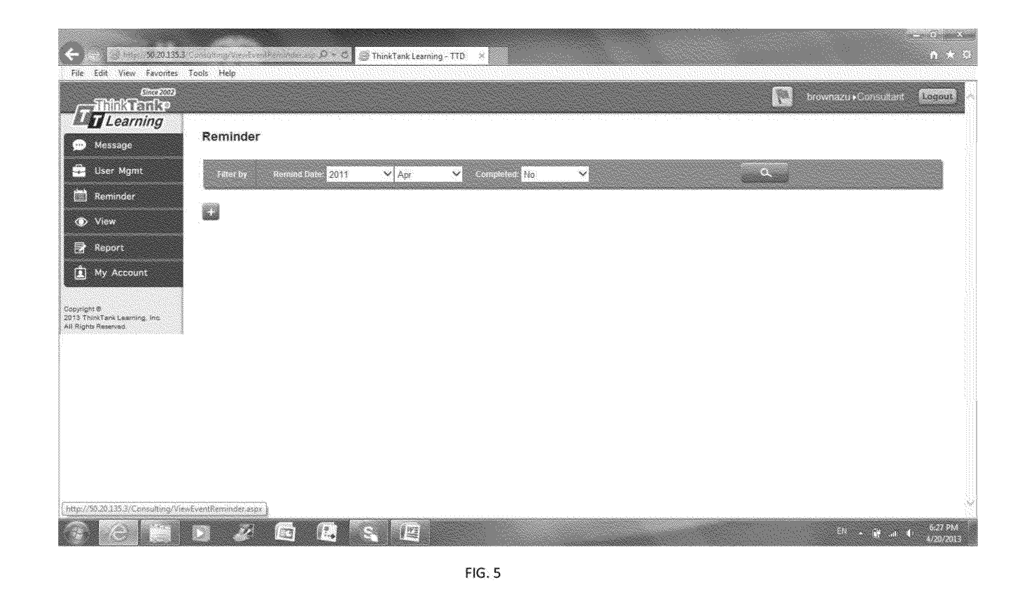

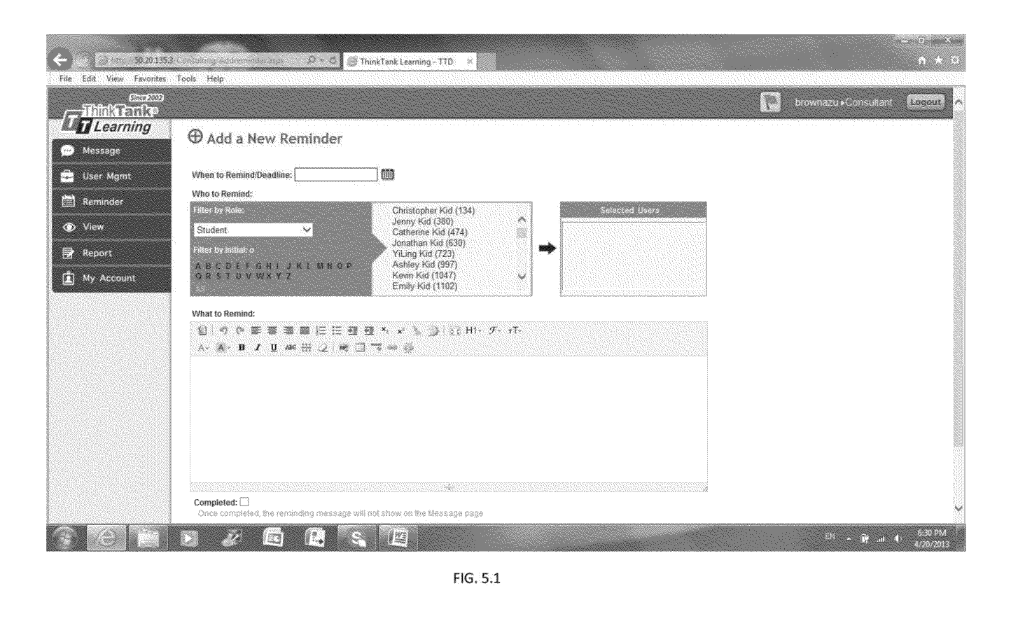

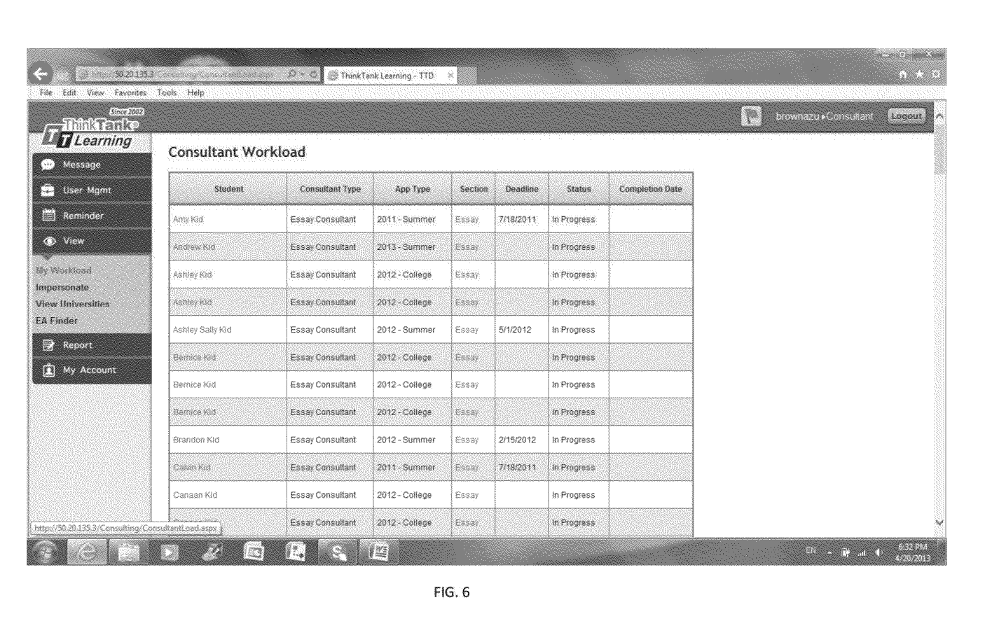

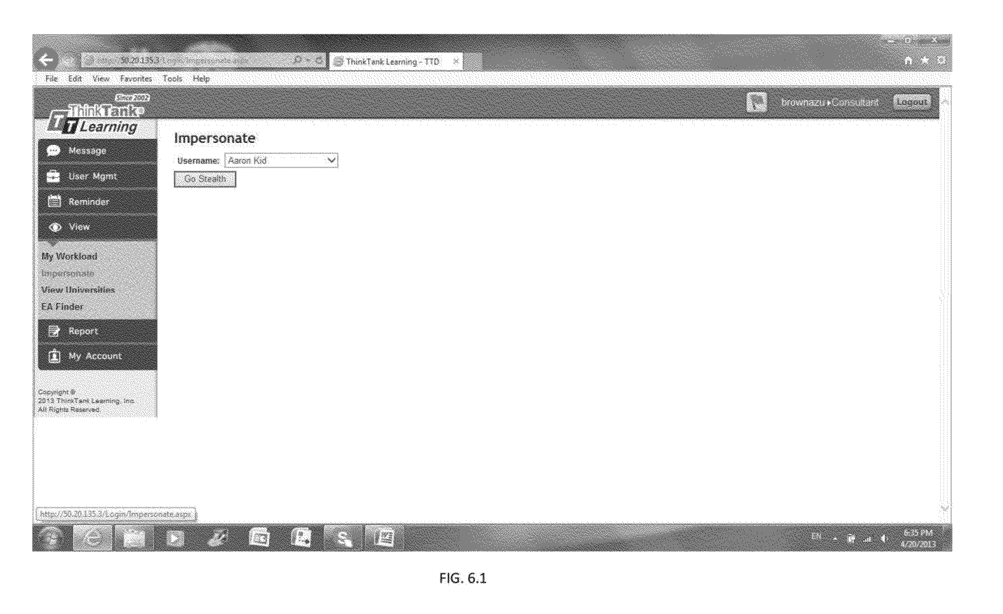

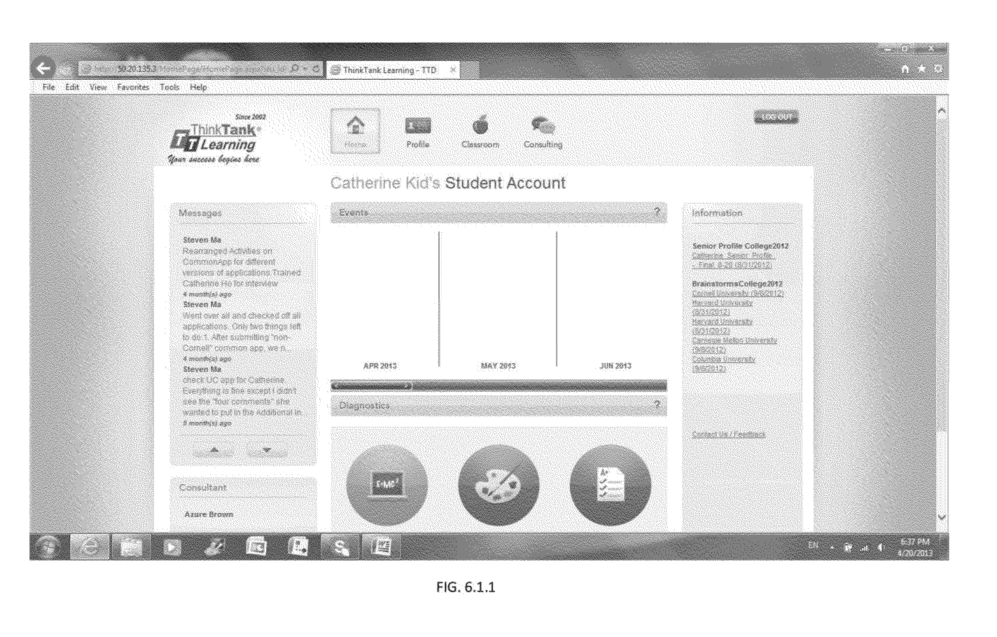

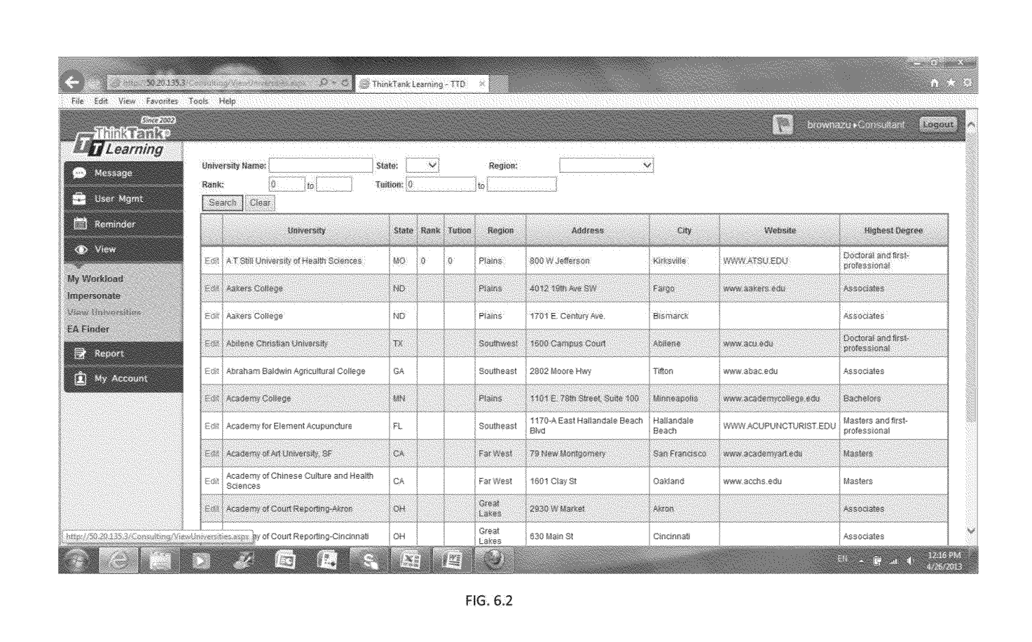

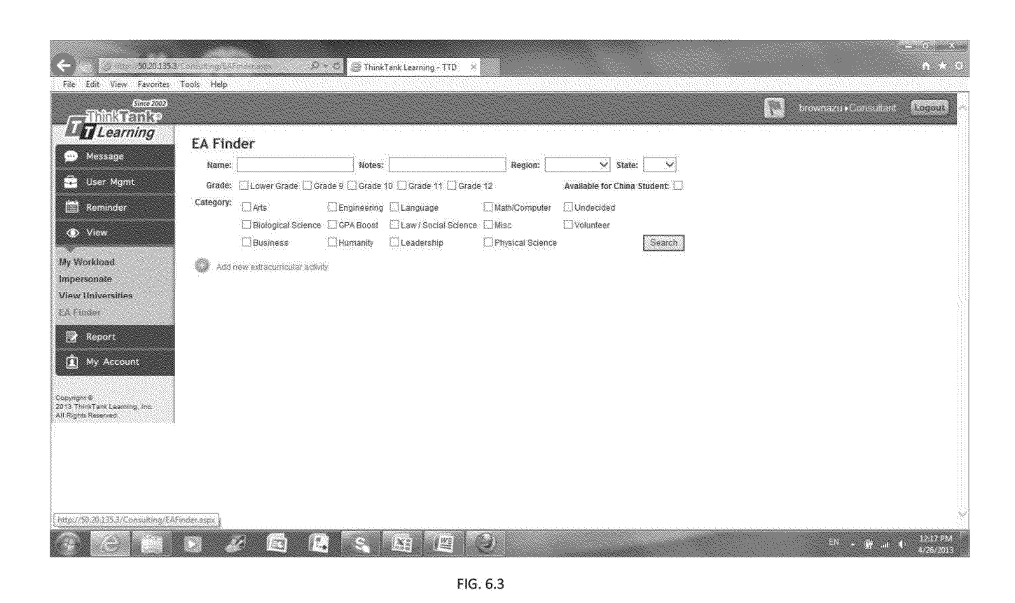

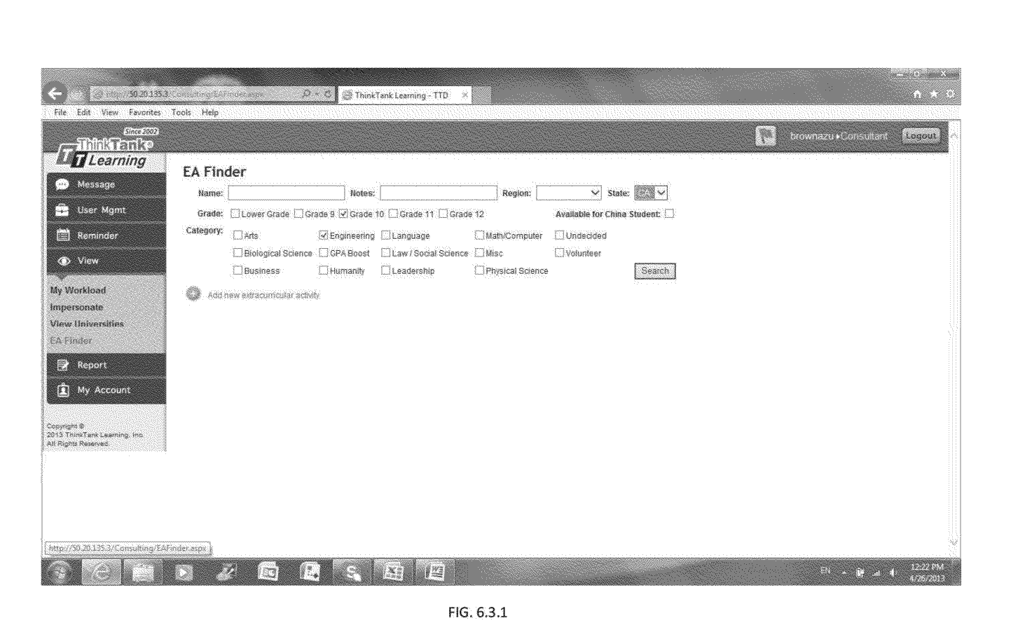

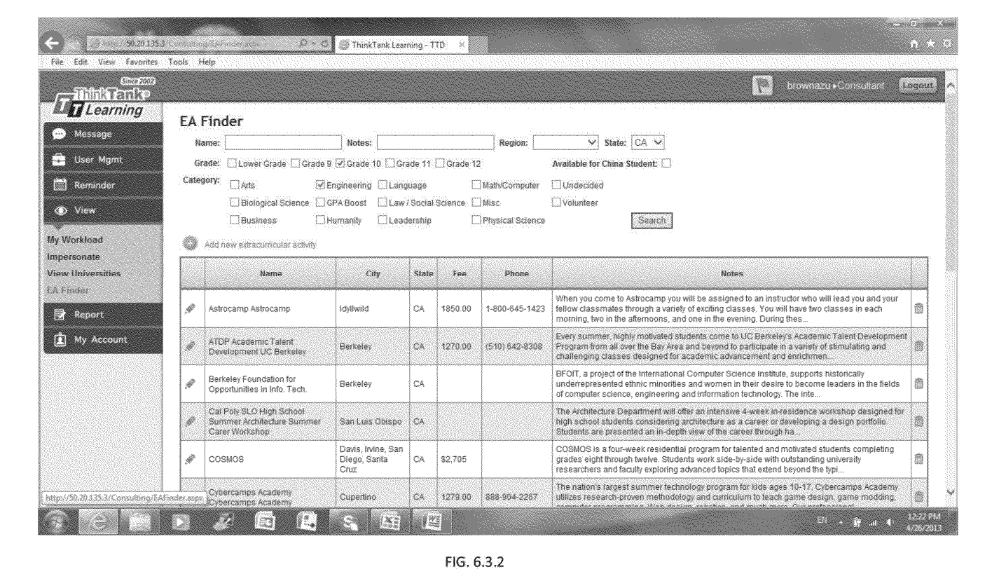

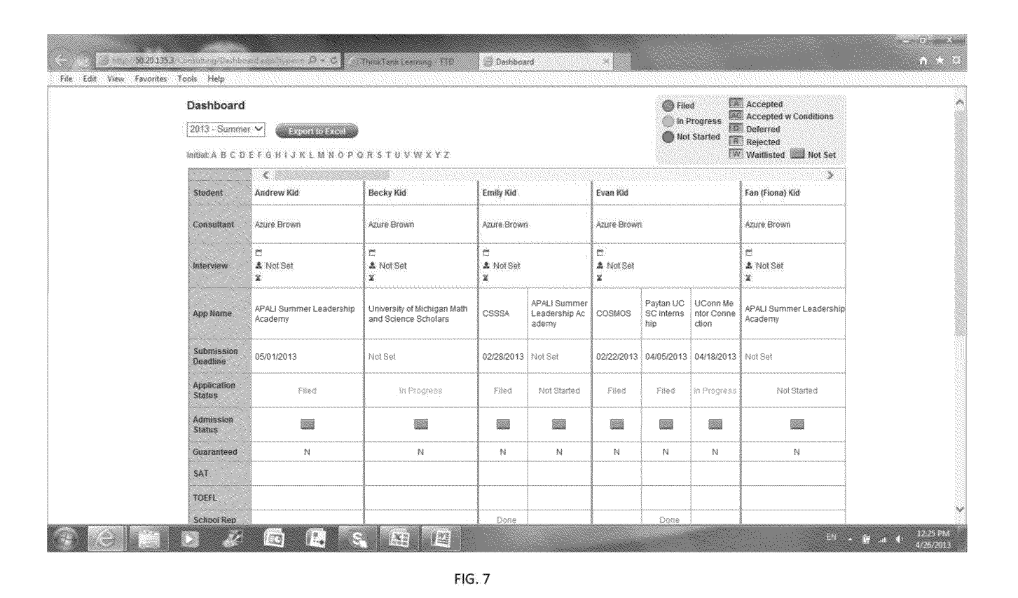

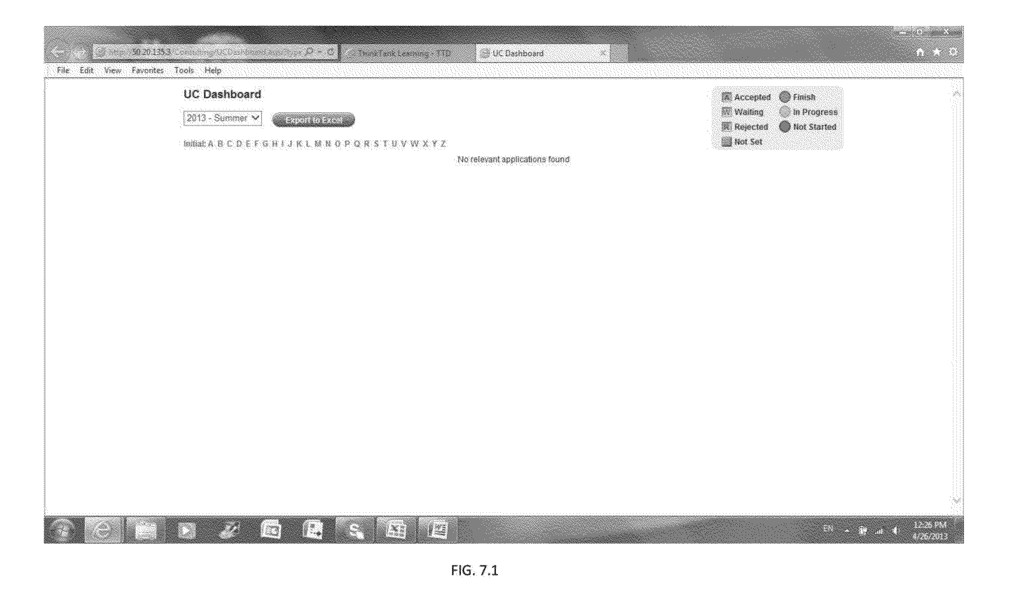

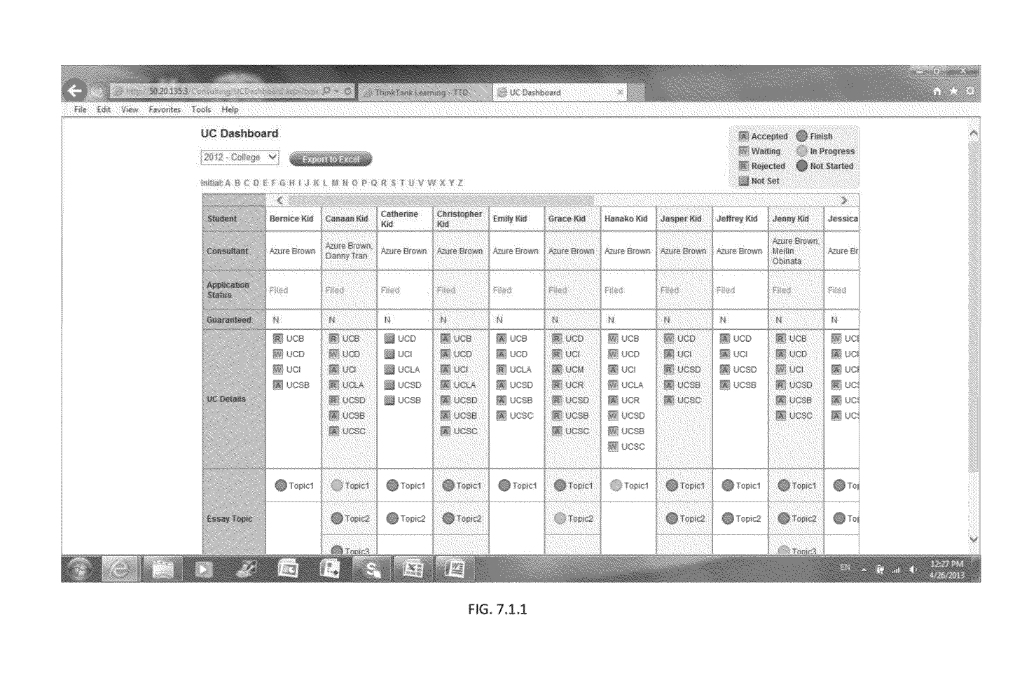

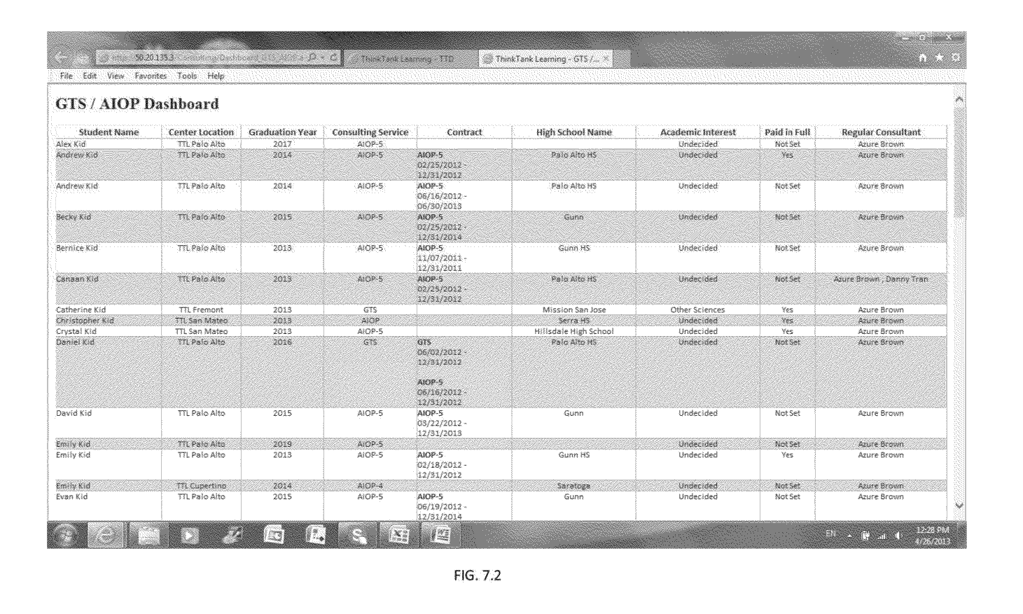

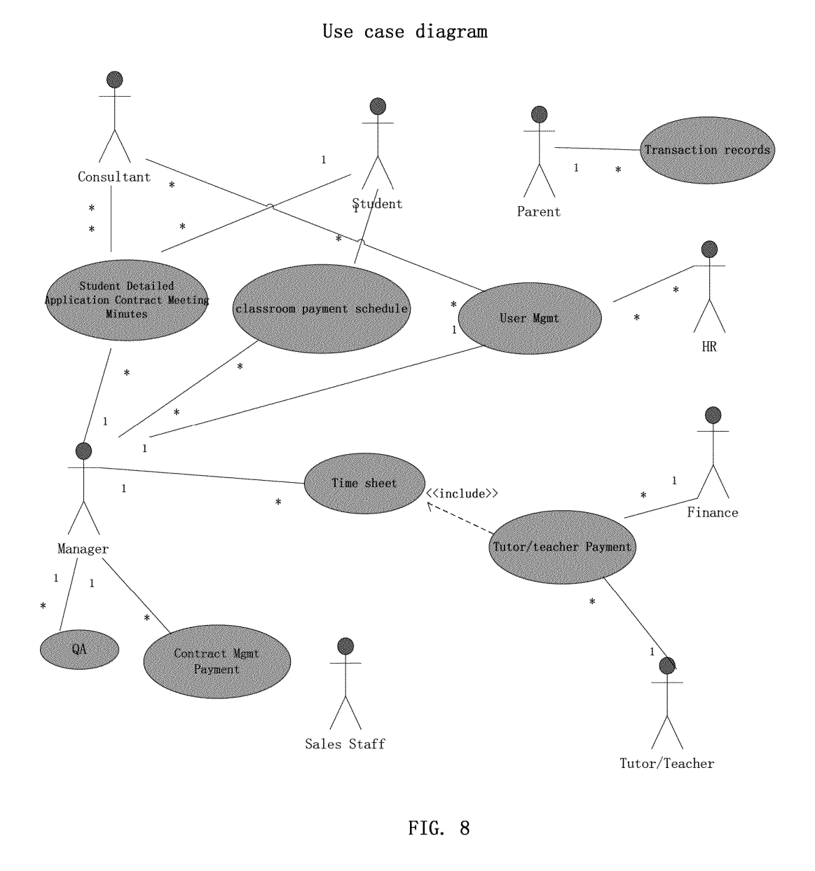

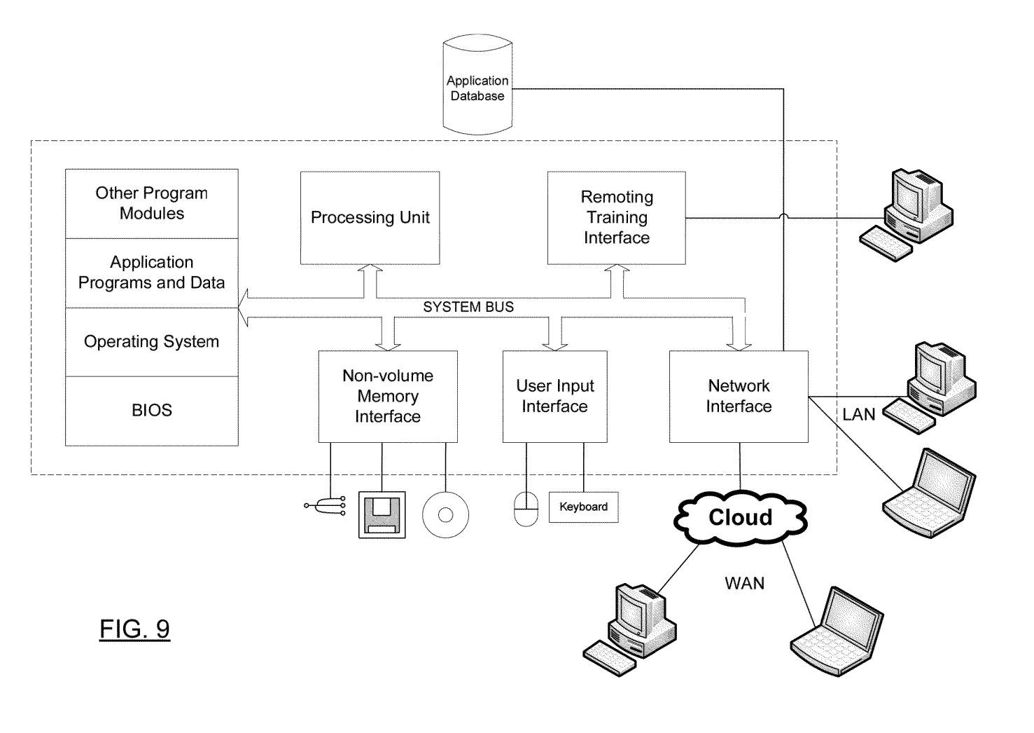

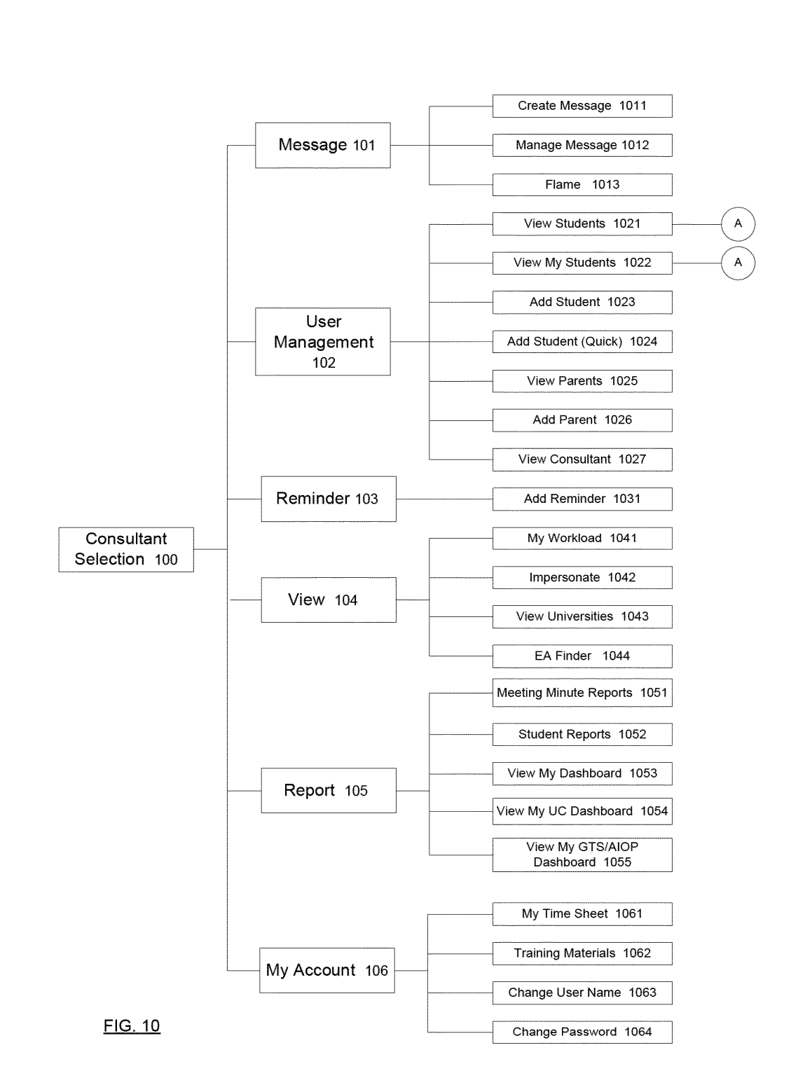

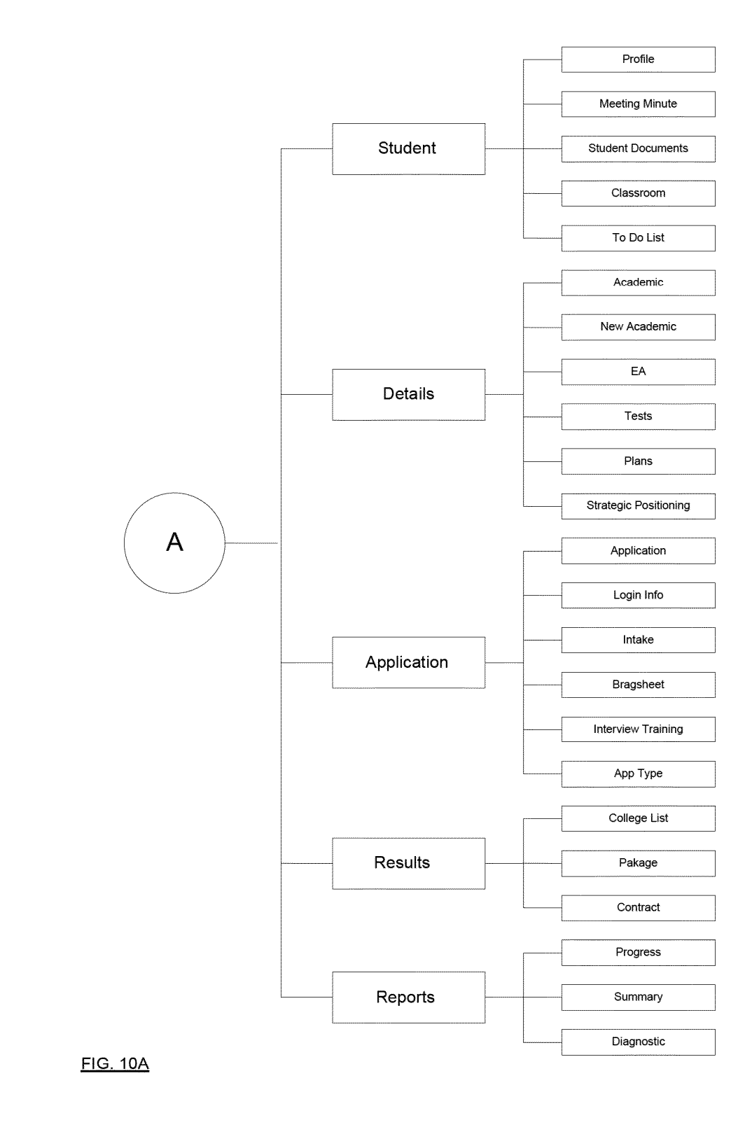

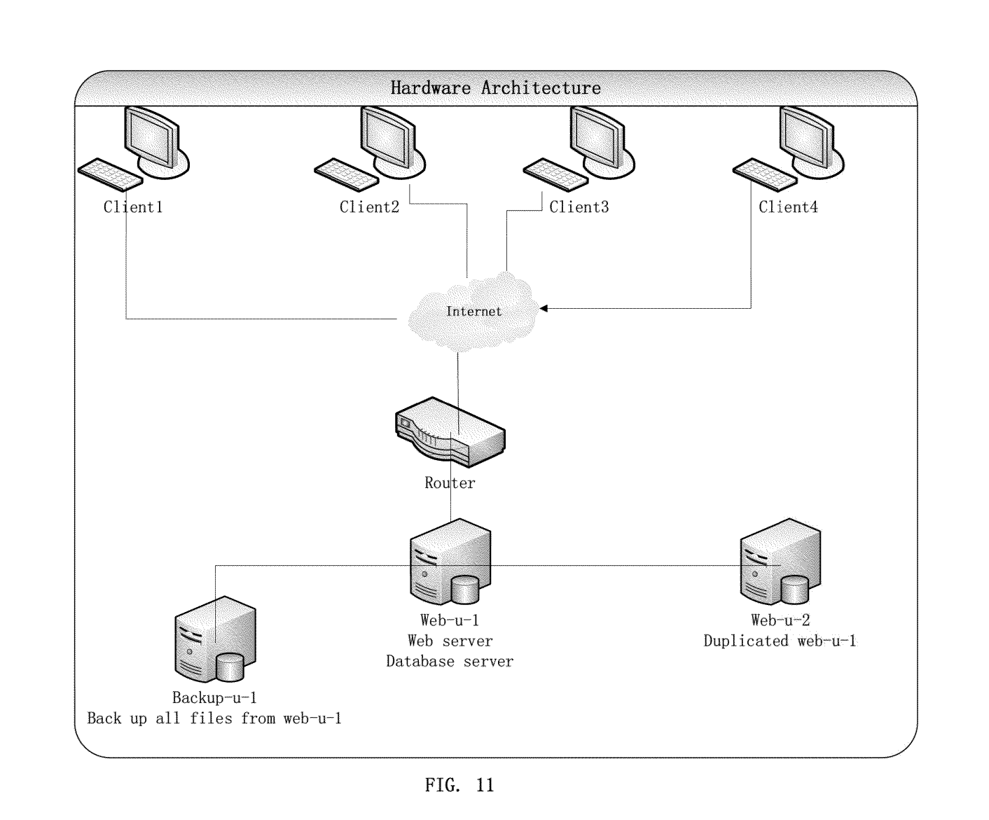

FIG. 4.1.1.1, a window showing the consultant entered content after the intake is done for the designated student;

FIG. 4.1.2, a window showing the ‘Strategic Positioning’ screen after a designated student's name is selected;

FIG. 4.1.2.1, a window showing the consultant entered content of the ‘Strategic Positioning’ for the designated student;

FIG. 4.1.3, a window showing the ‘Diagnostic’ result for the designated student, wherein Tier 2 is preselected;

FIG. 4.1.3.1, a window showing the ‘Diagnostic’ result for the designated student, the Academic, Test, and EA analysis;

FIG. 4.1.3.2, a flow chart for Diagnostic processing;

FIG. 4.1.4, a window showing the ‘Application’ for all the school application statuses for the designated student;

FIG. 4.1.4.1, a window showing one of the school application statuses (whether it's using common application, essay topic, and submission date) under ‘Application’.

FIG. 4.1.5 and FIG. 4.1.5.1, a window showing the ‘Academic’ screen for a student's academic information;

FIG. 4.1.6, a window showing the ‘Tests’ screen for a student's standardized test scores;

FIG. 4.1.7 and FIG. 4.1.7.1, a window showing the ‘College List’ screen for selected schools, and their chances for admission;

FIG. 4.1.8, a window showing the ‘Progress’ report for all school applications;

FIG. 4.2, a window showing the ‘Add Student’ screen;

FIG. 4.3, a window showing the ‘Add Student (Quick) screen;

FIG. 4.4, a window showing the ‘View Parents’ screen;

FIG. 4.5, a window showing the ‘Add parent’ screen;

FIG. 4.6, a window showing the ‘View Consultants’ screen;

FIG. 5, a window showing the ‘Reminder’ screen;

FIG. 5.1, a window showing the ‘Add a New Reminder’ screen;

FIG. 6, a window showing the ‘My Workload’ screen for the consultant under the ‘View’;

FIG. 6.1, a window showing the ‘Impersonate’ screen under the ‘View’;

FIG. 6.1.1, a window showing the view when the consultant impersonated as a student;

FIG. 6.2, a window showing the ‘View Universities’ screen under the ‘View’;

FIG. 6.3, a window showing the ‘EA Finder’ screen under the ‘View’;

FIG. 6.3.1, a window showing the ‘EA Finder’ options for a user to enter desired category (e.g. Grade 10, Engineering related in California);

FIG. 6.3.2, a window showing the ‘EA Finder’ results screen after user entered category;

FIG. 7, a window showing the ‘View My Dashboard’ screen;

FIG. 7.1, a window showing the ‘View My UC Dashboard’;

FIG. 7.1.1, a window showing the ‘View My UC Dashboard’ results;

FIG. 7.2, a window showing the ‘View My GTS/AIOP Dashboard’ screen, for students with Guaranteed Total Solution (GTS) and All-In-One-Program (AIOP) contracts;

FIG. 8 illustrates a Data Use Diagram;

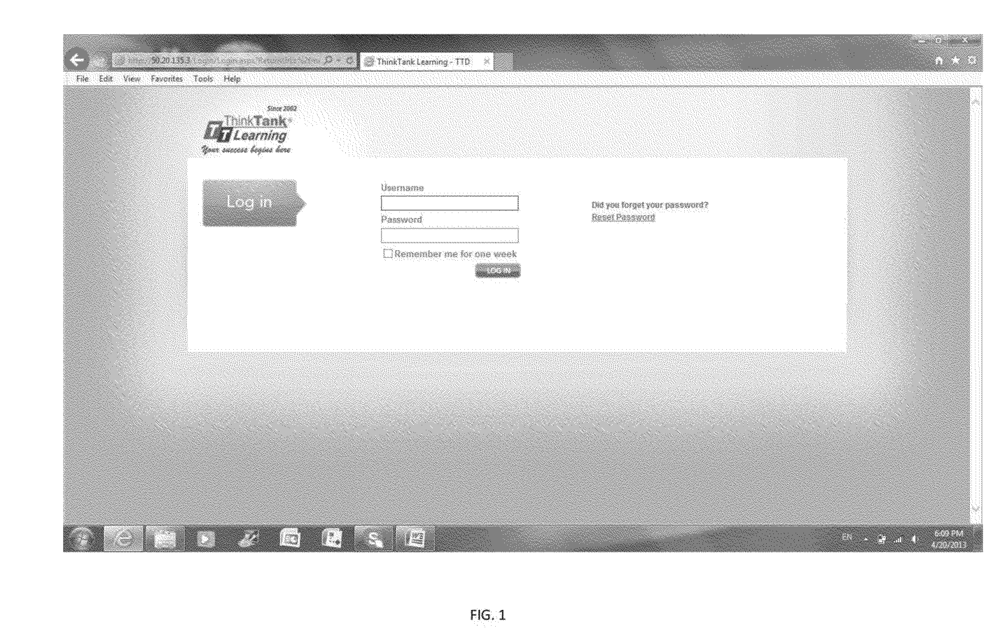

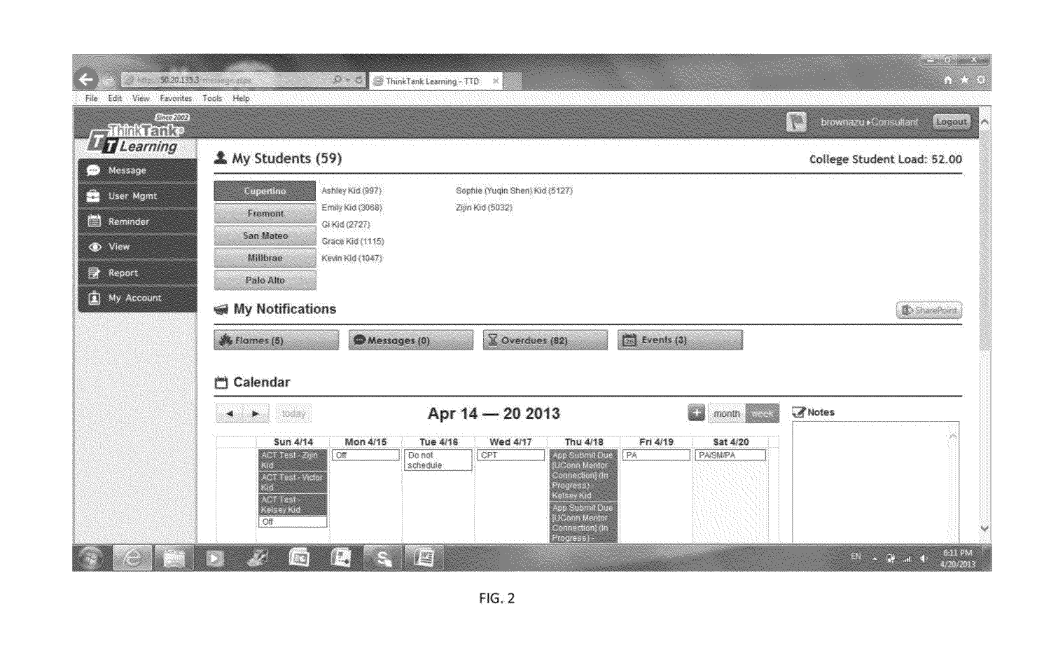

FIG. 9 illustrates an exemplary computer system that can be configured to perform the educational consulting processes of FIGS. 1-8;

FIG. 10 and FIG. 10A illustrate a functional block diagram showing the education consultant's operations of the current invention;

FIG. 11 illustrates a hardware architecture diagram for the education counseling system.

### DETAILED DESCRIPTION OF THE PREFERRED EMBODIMENTS

The present invention is directed to a system that enables an educational consultant to have a very thorough and personal understanding about the student and to provide a tailored guidance to the student according to the personal understanding. The present invention provides specialized interfaces for different users of the educational system, each interface allows a special user to enter, retrieve, and modify a special set of data. The data entered and modified by different users are stored in a shared database and their accesses are controlled according to the authentication of each user. For example, the educational consultant uses the data from the students and the data collected from the universities to develop an action plan for the student. The action plan is executed by the student and the execution of the action plan is monitored by the educational consultant through the specialized interface provided by the present invention.

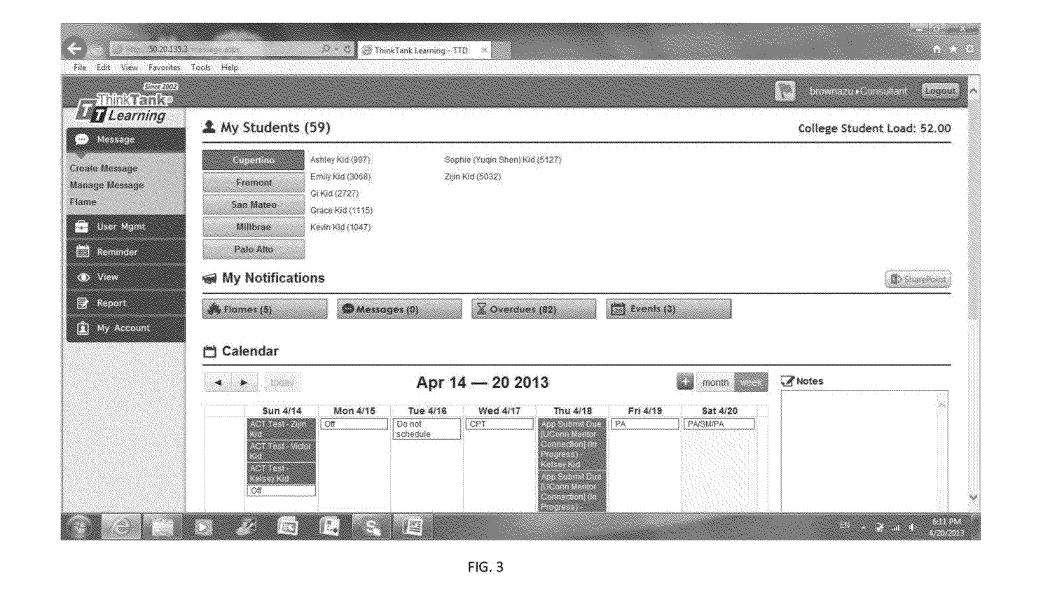

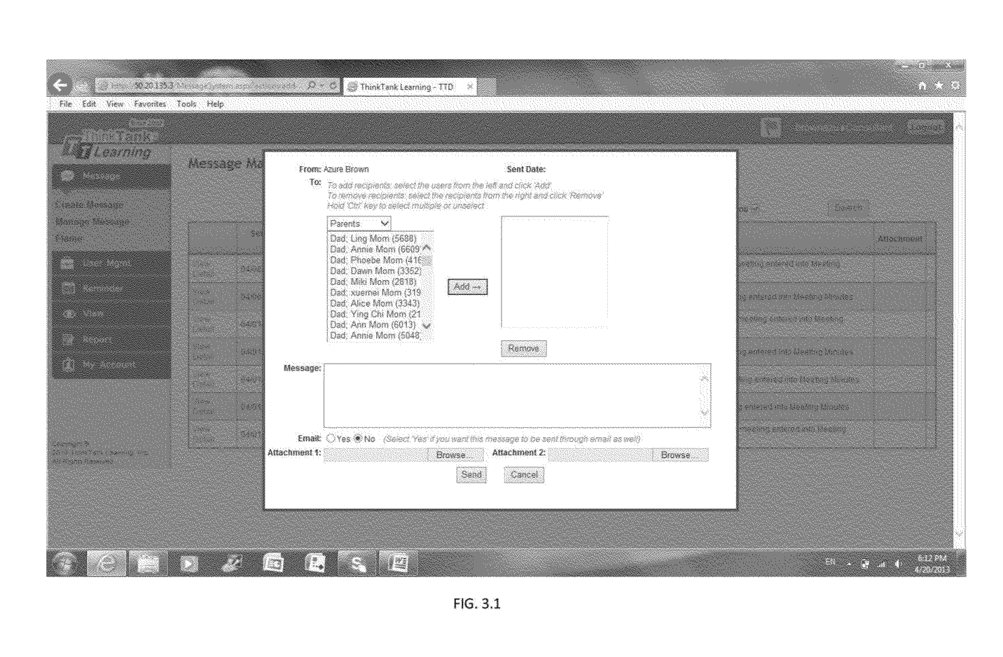

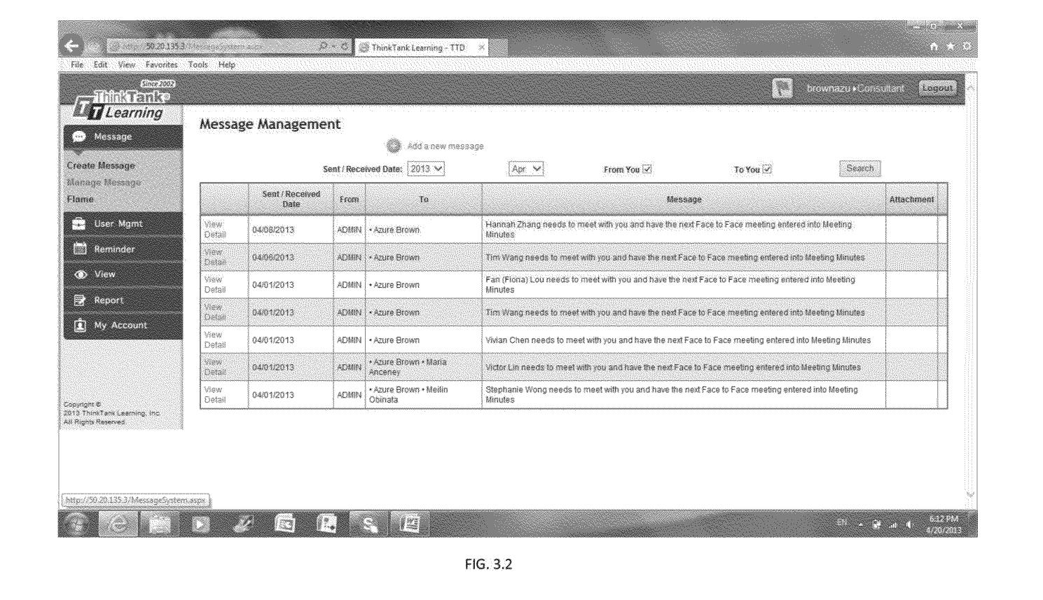

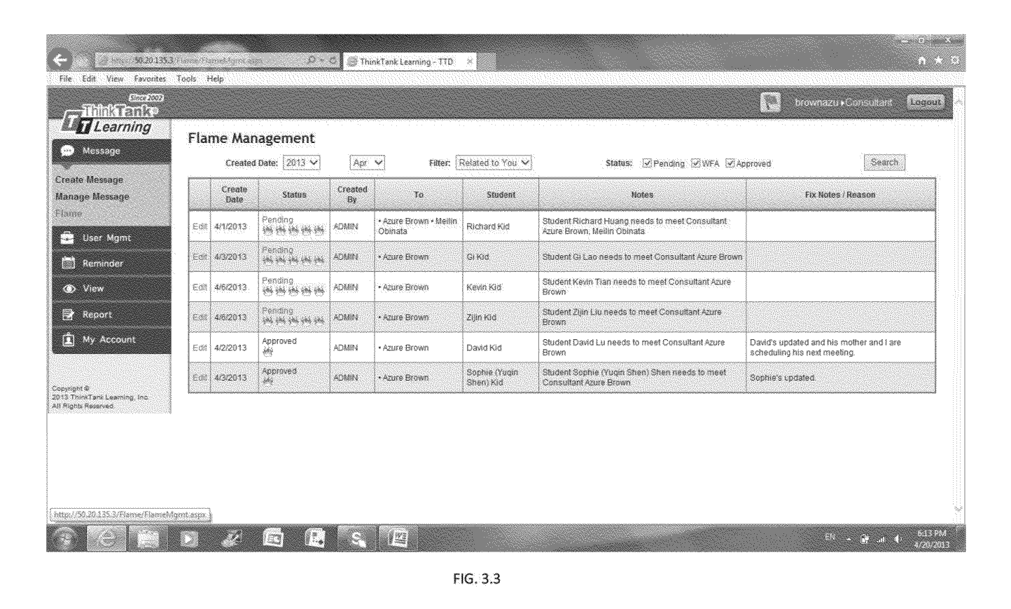

When the consultant logs in the system (FIG. 1), he/she will see the welcome page with his/her student names and a calendar of current week displayed (FIG. 2). The consultant normally communicates with his students via email, he/she can use message functions to create/send messages (FIG. 3 and 3.1), manage/receive messages (FIG. 3.2), and set ‘flame’ for urgent messages (FIG. 3.3). The consultant can also view students and parents information under the ‘User Mgmt’ options (FIGS. 4, 4.1, 4.2, 4.3, 4.4, 4.5, and 4.6).

The education consultation begins with the educational consultant conducting an intake (interview) with the student, during the intake, the education consultant would ask the student about his/her growing up background, such as his/her relationship with parents/siblings, his/her happiest/saddest things, special events, obstacles to overcome, greatest accomplishments, hobbies/interest, any unique stories, and personality etc.; basically the education consultant can ask any question that will help him/her to get a better understanding about the student. All the answers were documented in educational counseling database see FIG. 4.1.1 and FIG. 4.1.1.1. The education consultant then uses a system template to provide a ‘strategic positioning’ statement (data) for the student (FIG. 4.1.2 and FIG. 4.1.2.1); such as “Catherine is the future Madeleine Albright, a true diplomat”, which basically outlined the student, Catherine, is a student with a strong communication skill and an uncanny ability to bridge the chasms between non-intersecting worlds. Her major efforts and experiences are also summarized as “Whether is it the founding of business and calligraphy clubs, or teaching of calligraphy, or interning at State offices, Catherine's world cannot be easily summarized or categorized. For a simple reason, Catherine has a wide range of interest and a big heart to inspire others . . . Between her personal life and her academic one, Catherine has spent hundreds of hours working in government jobs. Beginning from city level government to eventually the office of California Lieutenant Governor, she contributed mostly with her ability to connect with people and addressing their concerns.” The phrase in the strategic planning is also used to remind the consultant that what personality that Catherine has; the consultant will then further illustrate on her specific stories to support this phrase. The strategic positioning statement will also used as a guideline for the student's college essays eventually.

In general, the college application selection evaluates three main areas, they are: (1) Student's Academics; including GPA, Honor classes, A-G courses (A: History/Social Science; B: English; C: Mathematics; D: Laboratory science; E: Language other than English; F: Visual and Performing Arts; and G: College-preparatory elective); (2) Standardized Tests; which including SAT or ACT, SAT subject test(s), AP, and TOEFL or IELTS for international applicants; and (3) Extracurricular Activities (EA), which including Clubs, Sports, Leaderships, Volunteer works, internships, awards etc. The present invention includes a ‘diagnostic’ function, which is performed on the student data for these three areas. After a target school tier is selected, and all the three areas data are stored, the system would generate a report based on a special algorithm, the report will indicate what area the student still needs improvement for the selected tier. For example, in Catherine's case, she is projecting tier 2 schools (US News™ ranked number 17-28 schools), which requires GPA to be 3.75, but her GPA is 3.72, which met the threshold, therefore the Diagnostic report shows orange color in the Academic circle (green circle means requirement is met, i.e. student's score is greater than the required score; red circle means the student needs a big improvement), see FIG. 4.1.3., FIG. 4.1.3.1., and FIG. 4.1.3.2. The diagnostic function is based on special factors, they are defined for each tier of the schools; such as for tier 1 ranking schools (US News ranked 1-16 schools), the minimum Academic requirements for GPA is 3.85. A-G course units is 56 (one semester of English=1 unit; one year, that is two semesters, of Math=2 units). And Honors class units is 20. However, Academic is weighing 30%, and EA is 70% for the overall evaluation, which means for top ranked schools, EA are evaluated high. For EAs, they are categorized as ‘Club’, ‘Sports’, ‘Talents’, ‘Leadership’, ‘Education Prep’, ‘Volunteer’, ° work', and ‘Signature Project’; each of them with a minimum required events; for example, for tier 1 schools, the student needs three club events, two sports, three talent events, two leadership events, minimum 450 volunteer hours, two work events, and two Signature projects. The EA number is calculated by a complicated formula, for example, each student participated event is assigned by a specific number, adding up all the event numbers divided by a specific factor to get the student's EA score. If the student's EA score is greater than the targeted score, the EA displays green circle, if the EA score is less or equal to the targeted score, the EA circle will be flagged to red (less) or orange (equal) color. If the diagnostic report generated indicates that the targeted tier is too difficult to reach, the system informs the student by flagging the circle in orange or red, student can modify his target tier to a lower ranked tier, for example for tier 2 schools (US News ranked 17-28 schools), the GPA requirement is 3.75, A-G units is 52, Honor classes is 16, etc. All the tier factors used for the diagnostic function are subject to change; they can vary from year to year and the system will update the tier factors according to the data collected from the universities.

The student's academic data, which includes classes he/she has taken since grade 7 to grade 12, grades he/she has obtained, honor type, they are entered and able to be viewed under ‘Academic’ option, see FIG. 4.1.5 and FIG. 4.1.5.1.

The student's standardized test scores are also entered by the consultant and stored in the education counseling system, which can be viewed under ‘Tests’ option, see FIG. 4.1.6.

Each student normally applies ten or more schools, therefore it's very convenient for the education consultant to have a summarized view for his entire student's application statuses, the education consultant can select ‘Application’ button to check the student's application statuses, see FIG. 4.1.4.

For each of the school's application status, including whether it's using common application, its essay topic, and submission deadline, can be retrieved from the student database and made available by clicking on that school under ‘Application’, see FIG. 4.1.4.1.

An analysis for chances of admissions for each of the applied schools is also provided in ‘College List’ screen, see FIG. 4.1.7, and FIG. 4.1.7.1; wherein, admission chances are calculated based on a unique algorithm and the student data, and the results are divided into seven levels, they are: VU (a chance of admission is 15% or lower), VU/R (a chance of admission is between 15% to 35%), R (a chance of admission is approximately 35%), R/T (a chance of admission is between 40 to 55%), T (a chance of admission is approximately 60%), T/S (a chance of admission is between 65% to 75%), and S (a chance of admission is greater than 75%). The chance of admission is also used to decide what type of contract the student should use. If the student has high chances to be admitted to his/her targeted schools, a Guaranteed Total Solution (GTS) contract can be used. This function is very helpful for marketing staff to use when determining the contract type. The calculation is based on a statistic model that was generated from the historical admission data.

An overall school application progress for each student can be viewed under ‘Progress’, wherein school name, brainstorm approval status (every brainstorm document has to be approved by a supervisory consultant), essay name, essay deadline, essay approval status, application status and admission status are listed, see FIG. 4.1.8.

In order to remind the consultant what workload he/she has, a quick summary of all students consulting types, application types, deadlines, sections, deadlines, and statuses are listed in the ‘My Workload’, see FIG. 6.0.

The consultant selects schools for the student based on his/her intended major, geographical preferences, ranking, tuition, school's size (all the information are in View Universities, see FIG. 6.2). After the school selection is finalized by the consultant, the system presents the finalized school selection to the student for approval. The school selection approval can also be done by student's parents. Once all the schools are determined and agreed by the student and his/her parents, all the information about the application are retrieved from the education counseling system automatically; which includes the essay topics, application deadlines for the selected schools, plus the student's log on ID for each of the schools that she/he has applied are entered into the student's account. An application status is generated by the system for the application and can be monitored by the student, the consultant, as well as the parents, along the line.

The consultant may forget what information he/she has sent to a student, therefore the education consultant can also impersonates any of his/her students, in order to see what messages the education consultant has sent to that students, he/she can do it by selecting ‘Impersonate’ button, see FIG. 6.1 and FIG. 6.1.1.

The system further includes ‘View Universities’ function, where the system displays university names based on school ranking, majors, state or region, that allows the student and his parent to learn more about different universities. See FIG. 6.2.

Since the Extracurricular Activity is a major evaluation criteria for students applying for college, the present invention further includes Extracurricular Activity (EA) searching function to aid the education consultant to plan for extracurricular activities. The system would list the EA that are available based on grade, category, and location, see ‘EA Finder’ screens in FIG. 6.3, 6.3.1, and 6.3.2; the education consultant can select the most appropriate one for the student based on his/her specific request. The list of the EA is compiled based on the data collected from different sources and stored in the system.

An educational consultant may add a student, add a parent, view parent information, and view coworker information. To add a student into the system, the consultant may use the screen shown on FIG. 4.2.

If the education consultant is speaking to a potential student over the phone, he/she can use the ‘Add Student (Quick)’ function, which catches very basic information about the student, see FIG. 4.3.

To view parent information, the consultant may use the ‘View Parents’ function, see FIG. 4.4. To add a new parent, use the screen shown on FIG. 4.5.

In order to search for coworker's information, when seeking for support from coworkers, the present invention allows education consultants to ‘view consultant’, see FIG. 4.6.

The present invention further includes ‘Reminder’ function, which is a very handy communication channel between an education consultant and his/her students, it reminds the student what tasks need to be finished. It also receives reminder from others to the education consultant, see FIGS. 5 and 5.1

In order to keep track of all the communication occurred between the education consultants and the students or the parents, all meetings (including phone calls or exchanged emails) are documented via the ‘Meeting Minute Reports’ function.

The education consultant often needs to check the student's academic performance, or standardized test scores; he can find those reports in ‘Student Reports’.

The education consultant normally works with more than 10 students, therefore it's very beneficial for him/her to be able to have a summarized view for all his students, he/she can select ‘View My Dashboard’ function, which lists an overview of all his/her students' application statuses, see FIG. 7.

There are nine schools under University of California system, and most students will select at least one UC school to apply (especially for students live in California); therefore a summary panel for all UCs that a student has applied is also available, via the ‘View My UC Dashboard’, see FIG. 7.1 and FIG. 7.1.1.

In order to ensure various services can be delivered for different contract types, Guaranteed Total Solution (GTS) or All-In-One-Program (NOP), a quick overview of student's contract type is also available, via ‘View my GTS/AIOP Dashboard’ function, see FIG. 7.2.

FIG. 8 is a data use diagram, it shows the data can be accessed by different role(s); wherein the line indicates the type of role (user) can use the feature (oval shape). For example, Consultant, Student, and Manger can use/access “Student Detailed Application Contract Meeting Minutes”. It also shows the relationship is 1 to many (1,*), many to many (*, *), or 1 to 1.

FIG. 9 is an exemplary of a computing system environment in which the invention may be implemented. The educational counseling system can be implemented in such a computing system or anything that is similar to this computing system.

FIG. 10 and FIG. 10A are hierarchical view of functions available to an educational consultant. In FIG. 10, the education consultant 100 can select ‘Message’ 101, ‘User Management’ 102, ‘Reminder’ 103, ‘View’ 104, ‘Report’ 105, or ‘My account’ 106 in the window. The education consultant can use Message 101 functions to create/send messages 1011, manage/receive messages 1012, and set ‘flame’ for urgent messages 1013.

Under ‘User Management’ 102, he/she can select either ‘View Student’ 1021, ‘View My student’ 1022, ‘Add Student’ 1023, ‘Add Student (Quick)’ 1024, ‘View Parent’ 1025, ‘Add Parent’ 1026, or ‘View Consultant’ 1027. If the education consultant selects ‘View Student’ 1021 or ‘View My student’ 1022, he/she will be able to look at detailed information for the selected student, which includes ‘Student’ 10A1, ‘Details’ 10A2, ‘Application’ 10A3, ‘Results’ 10A4, and ‘Reports’ 10A5. The information is categorized into these five categories for special purposes. The student's profile 10A11, all the meeting minutes 10A12, student document 10A13 (awards or special supporting files), classroom 10A14 (classes that the student is taking and progress), and ‘to do list’ 10A15 are all listed under ‘Student’ 10A1 category. Student's academic record 10A21, EA 10A22, standardized test results 10A23, plans 10A24, and strategic positioning 10A25 are all listed under ‘Details’ 10A2. All the school applications are under ‘Application’ 10A3 category, for example, Application 10A31 lists all the schools that the student is applying, ‘Login Info’ 10A32 for all the school portals and SAT/ACT login IDs. ‘Intake’ 10A33 records the information from interviewing the student. ‘Bragsheet’ 10A34 is a quick summary of the student's academic, test, EA and achievement. ‘Interview Training’ 10A35 is used if the student needs to take training for school interviews. ‘App Type’ 10A36 is for student's application year and type. ‘Results’ 10A4 shows the student's applications' results; an analysis for chances of admissions for each of the applied schools is provided in ‘College List’ screen 10A41; ‘package’ 10A42 shows summary of the chances, contract and bill. ‘Contract’ 10A43 shows contract content, billing and invoices. ‘Reports’ 10A5 provides summary reports for different categories. For example, if the education consultant is interested in the student's entire applications' progress, he can select ‘Progress’ 10A51 under ‘Reports’ 10A5, also see FIG. 4.1.8. ‘Summary’ 10A52 prints a complete summary for the student. ‘Diagnostic’ 10A53, based on a preselected school tier, the system will produce a result for Academics, Standardized Tests, and EAs for the student.

‘Reminder’ 103 is used by the education consultant to send reminding notes 1031 to the student what tasks need to be finished.

The first ‘View’ 104 option is ‘My Workload’ 1041, which is a quick summary of all students' consulting type, application type, deadlines, sections, deadlines, and statuses. ‘Impersonate’ 1042, impersonates his/her students, in order to see what messages the education consultant has sent to that students. The consultant can select schools for the student based on student's intended major, geographical preferences, ranking, tuition, school's size (all the information are in ‘View Universities’ 1043. The system would list the EA that are available based on grade, category, and location via the ‘EA Finder’ 1044; the education consultant can select the most appropriate one for the student based on his/her specific request.

‘Report’ 105 has five options. ‘Meeting Minute Reports’ 1051, it's used to keep track of all the communication occurred between the education consultants and the students or the parents, all meetings (including phone calls or exchanged emails) are documented via this function. ‘Student Reports’ 1052 is used to look at all the student's academic performance, or standardized test scores. ‘View My Dashboard’ 1053 is a summarized view for all his/her students, which lists an overview of all his/her students' application statuses. ‘View My UC Dashboard’ 1054, to view a summary panel for all UCs that a student has applied. ‘View My GTS/AIOP Dashboard’ 1055 provides a quick view of students' contract types.

‘My Account’ 106 functions are mostly used of managerial purpose, such as the ‘My Timesheet’ 1061, to enter his/her own service hours. ‘Training Materials’ 1062 is used to keep track of what training materials that the education consultant has used or borrowed. ‘Change User Name’ 1063 allows user to change his/her login ID, and ‘Change Password’ 1064′ allows user to change his/her password.

FIG. 11 is an exemplary hardware architecture of the present invention. Wherein Web-u-1 is the web and database server, the Web-u-2 is a backup web and database server designed for fault tolerance purpose, and the Backup-u-1 is used to backup all files from Web-u-1.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims. It is understood that features shown in different figures can be easily combined within the scope of the invention.

What is claimed is:

1. A computer-implemented method for an education consultant assisting a student in applying to schools, comprising:
collecting student information via an intake meeting with the student by the education consultant, and storing the student information in a data management system;
generating a strategic positioning data for the student by the education consultant according to the student information and storing the strategic positioning data in the data management system;
producing a college application essay brainstorm document for the student by the education consultant, and storing the college application essay brainstorm document in the data management system, wherein the college application essay brainstorm document is based on the strategic positioning data;
selecting a school tier for the student;
collecting the student's academic data, extracurricular activities data, and standardized tests data for the student;
generating by the data management system, a diagnostic report for the student based on the academic data, the extracurricular data, the standardized test data and the selected school tier;
selecting schools based on the diagnostic report for the student;
calculating chance of admission by the data management system for each of the selected schools; and
creating the students school application statuses by the data management system based upon the selected schools.

2. The computer-implemented method of claim 1, further comprising:
viewing the student's school application statuses via viewing dashboard function; and
if any of the University of California schools was applied, viewing UC dashboard for school application statuses for the student.

3. The computer-implemented method of claim 1, further comprising:
planning extracurricular activities (EA) for the student by input specific request from the student.

4. The computer-implemented method of claim 1, the step of collecting the academic data, extracurricular activities data, and standardized tests data for the student further comprising:
detailing and storing the academic data of the student, wherein the academic data comprises GPA, Honors program, and A-G courses taken;
detailing and storing the extracurricular activities based on EA categories for the student; and
detailing and storing the standardized tests data of the student, wherein the standardized tests comprises AP, SAT or ACT, and SAT subject test scores.

5. The computer-implemented method of claim 4, wherein the EA categories including club, sports, talents, leadership, education prep, volunteer, work, and signature project.

6. The computer-implemented method of claim 1, further comprising applying tier factors for the selected school tier for each of the academic data, standardized tests data, and extracurricular activities data for calculating the diagnostic report.

7. The computer-implemented method of claim 6, wherein the tier factors for the academic data including: GPA for tier one school is equal or greater than 3.85, GPA for tier two school is equal or greater than 3.75, GPA for tier three school is equal or greater than 3.65, and GPA for tier four school is equal or greater than 3.5; wherein, the tier factors are adaptable, can be changed occasionally.

8. The computer-implemented method of claim 1, further comprising:
using a statistic model for the step of calculating the chance of admission for each of the selected schools.

9. The computer-implemented method of claim 1, further comprising:
impersonating, by the education consultant, the student.

10. The computer-implemented method of claim 1, further comprising:
documenting meeting minute reports based on the intake meeting.

11. A non-volatile computer storage media comprising computer executable instructions which, when executed by a computer system, cause the computer system to perform the steps of:
collecting a student information via an intake meeting with the student by an education consultant, and storing the student information in a data management system;
generating a strategic positioning data for the student by the education consultant according to the student information, and storing the strategic positioning data in the data management system;
producing a college application essay brainstorm document for the student by the education consultant, and storing the college application essay brainstorm document in the data management system, wherein the college application essay brainstorm document is based on the strategic positioning data;
selecting a school tier for the student;
collecting the student's academic data, extracurricular activities data, and standardized tests data for the student;
generating by the data management system, a diagnostic report for the student based on the academic data, the extracurricular data, the standardized test data and the selected school tier;
selecting schools based on the diagnostic report for the student;
calculating chance of admission by the data management system for each of the selected schools; and
creating the student's school application statuses by the data management system based upon the selected schools.

12. The computer storage media of claim 11, further comprising computer executable instructions for viewing the student's school application statuses for the student via viewing dashboard function; and
if any of the University of California schools was applied, viewing UC dashboard for school application statuses for the student.

13. The computer storage media of claim 11, further comprising computer executable instructions for planning extracurricular activities (EA) for the student by input specific request from the student.

14. The computer storage media of claim 11, wherein the step of collecting the academic data, extracurricular activities data, and standardized tests data for the student further comprising:
detailing and storing the academic data of the student, wherein the academic data comprises GPA, Honors program, and A-G courses taken;
detailing and storing the extracurricular activities based on EA categories for the student; and
detailing and storing the standardized tests data of the student, wherein the standardized tests comprises AP, SAT or ACT, and SAT subject test scores.

15. The computer storage media of claim 14, wherein the EA categories including club, sports, talents, leadership, education prep, volunteer, work, and signature project.

16. The computer storage media of claim 11, further comprising applying tier factors for the selected school tier for each of the academic data, standardized tests data, and extracurricular activities data for calculating the diagnostic report.

17. The computer storage media of claim 16, wherein the tier factors for the academic data including: GPA for tier one school is equal or greater than 3.85, GPA for tier two school is equal or greater than 3.75, GPA for tier three school is equal or greater than 3.65, and GPA for tier four school is equal or greater than 3.5; wherein, the tier factors are adaptable, can be changed occasionally.

18. The computer storage media of claim 11, further comprising:
using a statistic model for the step of calculating the chance of admission for each of the selected schools.

19. The computer storage media of claim 11, further comprising:
impersonating, by the education consultant, the student.

20. The computer storage media of claim 11, further comprising:
documenting meeting minute reports based on the intake meeting.
